(19) United States
(12) Patent Application Publication
(10) Pub. No.: US 2011/0040611 A1
(43) Pub. Date: Feb. 17, 2011

(54) USING COMPETITIVE ALGORITHMS FOR THE PREDICTION AND PRICING OF ONLINE ADVERTISEMENT OPPORTUNITIES

(76) Inventors: Willard L. Simmons, Boston, MA (US); Sandro N. Catanzaro, Arlington, MA (US)

Correspondence Address: GTC Law Group LLP & Affiliates, P.O. Box 113237, Pittsburgh, PA, 15241, US

(21) Appl. No.: 12/856,554

(22) Filed: Aug. 13, 2010

Related U.S. Application Data
(60) Provisional application No. 61/234,186, filed on Aug. 14, 2009.

(51) Int. Cl. G06Q 30/00

(52) U.S. Cl. 705/14.41

(57) ABSTRACT

In embodiments of the present invention, improved capabilities are described for applying a plurality of algorithms to predict performance of online advertising placements. The plurality of algorithms to predict performance may include advertiser data, historic event data, user data, real-time event data, contextual data, and third-party commercial data. Further, a computer program product, based on the methods and systems of the present invention, may include a set of instructions for tracking performance of the plurality of algorithms under a variety of market conditions. In embodiments, the computer program product may include a set of instructions for determining performance conditions for an algorithm, and/or include a set of instructions for tracking market conditions. Further, the computer program product may include a set of instructions for selecting an algorithm for predicting performance of advertising placements based on current market conditions.

### CROSS-REFERENCE TO RELATED APPLICATIONS

This application claims the benefit of the following commonly owned U.S. Provisional Patent Application, which is incorporated herein by reference in its entirety: App. No. 61/234,186 filed on Aug. 14, 2009 and entitled “Real-Time Bidding System for Delivery of Advertising.”

### FIELD OF THE INVENTION

The invention is related to using historical and real-time data associated with digital media and its use to adjust the pricing and delivery of advertising media.

### BACKGROUND

The management of presenting advertisements to digital media users is often characterized by a batch mode optimization scheme in which advertising content is selected for presentation to a chosen group of users, performance data is collected and analyzed, and optimization steps are then carried out to better future ad performance. This process is then iteratively run in a sequence of optimization analyses with the intention of improving an ad performance criterion, such as a completed transaction, through more informed ad-user pairings and other techniques. However, this optimization framework is limited in several important respects. For example, given the growth of digital media users brought about by popular innovations such as social networking, there is an over-abundance of data relating to digital media usage that cannot be accommodated and analyzed by the pre-planned, batch mode analytics of much of the current advertising performance modeling conducted in the industry. Furthermore, the batch mode of advertising analytics may force content groupings that do not correspond to the actual, and ever-changing, ad impression sequences that are occurring within a user's behavior, or across a pool of users. As a result, publishers of advertising content may be forced to unnecessarily utilize a number of ad networks to distribute their advertisements based at least in part on the plurality of optimization techniques and criteria used by the different ad networks. This may create redundancies and limit the ability to value the worth of an advertisement's impression and its performance over time within the totality of digital media users.

Therefore, there is a need for a method and system for valuing an impression of an advertisement to a digital media user using automated analytic techniques that are enabled to use historical and real-time data relating to advertisement performance as part of a learning system to optimize ad selection and assist valuation of advertisement presentation.

### SUMMARY

In embodiments, the present invention may provide methods and systems for applying a plurality of algorithms to predict performance of online advertising placements. The plurality of algorithms to predict performance may include advertiser data, historic event data, user data, real-time event data, contextual data, and third-party commercial data. Further, a computer program product, based on the methods and systems of the present invention, may include a set of instructions for tracking performance of the plurality of algorithms under a variety of market conditions. In embodiments, the computer program product may include a set of instructions for determining performance conditions for an algorithm, and/or include a set of instructions for tracking market conditions. Further, the computer program product may include a set of instructions for selecting an algorithm for predicting performance of advertising placements based on current market conditions.

In embodiments, a computer program product, based on the methods and systems of the present invention, when executed on one or more computers, may perform the step of predicting, using a primary model, an economic valuation of each of a plurality of available web publishable advertisement placements based in part on past performance and prices of similar advertisement placements. The primary model may be an active model that may respond to purchase requests. Further, the purchase requested may be a time limited purchase request. The computer program product may also perform the step of predicting, through a second model, an economic valuation of each of the plurality of web publishable advertisement placements. The second model may replace the primary model as the active model used to respond to purchase requests. The replacement may be based at least in part on a prediction that the second model may perform better than the primary model under the current market conditions. In embodiments, the prediction may be based at least in part on machine learning, historical advertising performance data, historical event data, and real-time event data. Furthermore, the computer program product, based on the methods and systems of the present invention, may perform the step of comparing the valuations produced by the primary model and the second model to determine a preference between the primary model and the second model. In the embodiment, comparing the valuations may include retrospectively comparing the extent to which the models may reflect actual economic performance of advertisements.

In embodiments, a computer program product, based on the methods and systems of the present invention, when executed on one or more computers, may perform the step of predicting, using a primary model, an economic valuation of each of a plurality of available mobile device advertisement placements based in part on past performance and prices of similar advertisement placements. The primary model may be an active model that may respond to purchase requests. Further, the computer program product may predict, through a second model, an economic valuation of each of the plurality of mobile device advertisement placements. The second model may replace the primary model as the active model and may respond to purchase requests. Furthermore, the replacement may be based on a prediction that the second model may perform better than the primary model under the current market conditions. In embodiments, the computer program product may compare the valuations that may be produced by the primary model and the second model to determine a preference between the primary model and the second model. Further, comparing the valuations may include retrospectively comparing the extent to which the models may reflect actual economic performance of advertisements.

While the invention has been described in connection with certain preferred embodiments, other embodiments would be understood by one of ordinary skill in the art and are encompassed herein.

### BRIEF DESCRIPTION OF THE FIGURES

The invention and the following detailed description of certain embodiments thereof may be understood by reference to the following figures:

FIG. 1A depicts a real-time bidding method and system for the delivery of advertising.

FIG. 1B depicts the execution of the real-time bidding system across multiple exchanges.

FIG. 2 depicts a learning method and system for optimizing bid management.

FIG. 3 depicts sample data domains that may be used to predict media success associated with key performance indicators.

FIG. 4 depicts training multiple algorithms relating to an advertising campaign, in which better performing algorithms may be detected.

FIG. 5A depicts the use of micro-segmentation for bid valuation.

FIG. 5B depicts a microsegmentation analysis of an advertising campaign.

FIG. 5C depicts optimization of pricing through frequency analysis.

FIG. 5D depicts how pacing may be optimized through recency analysis within the real-time bidding system.

FIG. 6 depicts the use of nano-segmentation for bid valuation.

FIG. 7 depicts a sample integration of a real-time bidding method and system within a major media supply chain.

FIG. 8A depicts a hypothetical case study using a real-time bidding method and system.

FIG. 8B depicts a second hypothetical case study comparing two advertising campaigns using a real-time bidding method and system.

FIG. 9 depicts a simplified use case in the form of a flow chart summarizing key steps that a user may take in using a real-time bidding method and system.

FIG. 10 depicts an exemplary embodiment of a user interface for a pixel provisioning system that may be associated with the real-time bidding system.

FIG. 11 depicts an exemplary embodiment of impression level data that may be associated with the real-time bidding system.

FIG. 12 depicts a hypothetical advertising campaign performance report.

FIG. 13 illustrates a bidding valuation facility for real-time bidding and valuation for purchases of online advertising placements.

FIG. 14 illustrates a method for real-time bidding and economic valuation for purchases of online advertising placements.

FIG. 15 illustrates a method for determining a bid amount.

FIG. 16 illustrates a method automatically placing a bid on the optimum placement for an advertisement

FIG. 17 illustrates facilities of the analytic platform that may be used for targeting bids for online advertising purchases in accordance with an embodiment of the invention.

FIG. 18 illustrates a method for selecting and presenting to a user at least one of a plurality of available placements based on an economic valuation.

FIG. 19 illustrates a method for the prioritization of available advertising placements derived from an economic valuation.

FIG. 20 illustrates a real-time facility for selecting alternative algorithms for predicting purchase price trends for bids for online advertising.

FIG. 21 illustrates a method for predicting performance of advertising placements based on current market conditions

FIG. 22 illustrates a method for determining a preference between a primary model and a second model for predicting economic valuation.

FIG. 23 illustrates a method for determining a preference between a primary model and a second model for predicting economic valuation.

FIG. 24 illustrates a method for selecting one among multiple competing valuation models in real-time bidding for advertising placements.

FIG. 25 illustrates a method for replacing a first economic valuation model by a second economic valuation model for deriving a recommended bid amount for an advertising placement.

FIG. 26 illustrates a method for evaluating multiple economic valuation models and selecting one valuation as a future valuation of an advertising placement.

FIG. 27 illustrates a method for evaluating in real time multiple economic valuation models and selecting one valuation as a future valuation of an advertising placement.

FIG. 28 illustrates a method for evaluating multiple bidding algorithms to select a preferred algorithm for placing an advertisement.

FIG. 29 illustrates a method for replacing a bid recommendation with a revised bid recommendation for an advertising placement.

FIG. 30 illustrates a real-time facility for measuring the value of additional third party data.

FIG. 31 illustrates a method for advertising valuation that has the ability to measure the value of additional third party data.

FIG. 32 illustrates a method for computing a valuation of a third party dataset and billing an advertiser a portion of the valuation.

FIG. 33 illustrates a method for computing a valuation of a third party dataset and calibrating a bid amount recommendation for a publisher to pay for a placement of an ad content based at least in part on the valuation.

FIG. 34 depicts a data visualization embodiment presenting a summary of advertising performance by time of day versus day of the week.

FIG. 35 depicts a data visualization embodiment presenting a summary of advertising performance by population density.

FIG. 36 depicts a data visualization embodiment presenting a summary of advertising performance by geographic region in the United States.

FIG. 37 depicts a data visualization embodiment presenting a summary of advertising performance by personal income.

FIG. 38 depicts a data visualization embodiment presenting a summary of advertising performance by gender.

FIG. 39 illustrates an affinity index, by category, for an advertising campaign.

FIG. 40 depicts a data visualization embodiment presenting a summary of page visits by the number of impressions.

### DETAILED DESCRIPTION

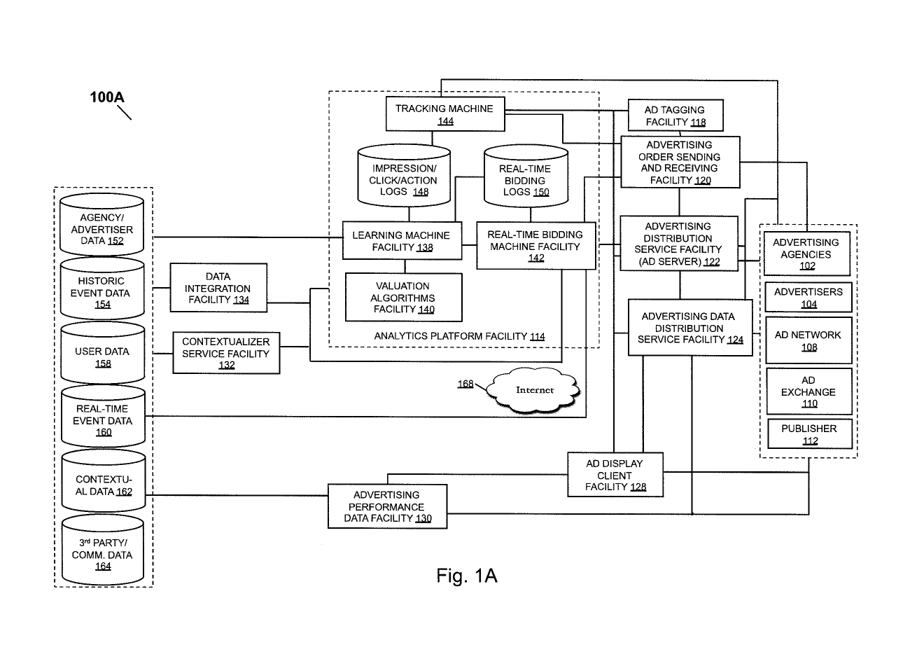

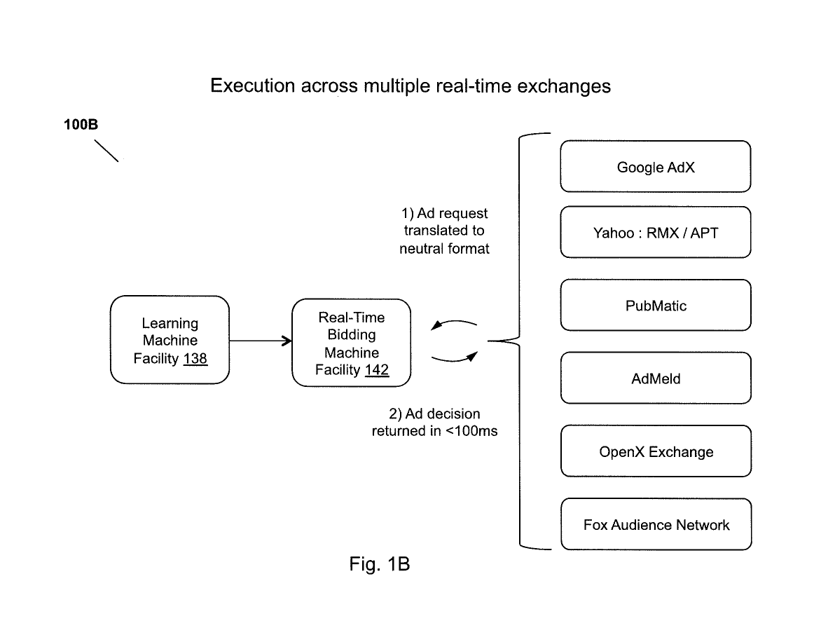

Referring to FIG. 1A, a real-time bidding system 100A that may be used according to the methods and systems as described herein for selecting and valuing sponsored content buying opportunities, real-time bidding, and placing sponsored content, such as advertisements, across a plurality of content delivery channels. The real-time bidding facility may inform buying opportunities to place sponsored content across multiple advertisement (“ad”) delivery channels. The real-time bidding facility may further enable the collection of data regarding ad performance and use this data to provide ongoing feedback to parties wanting to place ads, and automatically adjust and target the ad delivery channels used to present sponsored content. The real-time bidding system 100A may facilitate the selection of a particular ad type to show in each placement opportunity, and the associated costs of the ad placements over time (and, for example, adjusted by time of placement). The real-time facility may facilitate valuation of ads, using valuation algorithms, and may further optimize return on investment for an advertiser 104.

The real-time bidding system 100A may include, and/or be further associated with, one or more distribution service consumers, such as an advertising agency 102 or advertiser 104, an ad network 108, an ad exchange 110, or a publisher 112, an analytics facility 114, an ad tagging facility 118, an advertising order sending and receiving facility 120, and advertising distribution service facility 122, an advertising data distribution service facility 124, an ad display client facility 128, an advertising performance data facility 130, a contextualizer service facility 132, a data integration facility 134, and one or more databases providing different types of data relating to ads and/or ad performance. In an embodiment of the invention, the real-time bidding system 100A may include an analytic facility that may, at least in part, include a learning machine facility 138, a valuation algorithms facility 140, a real-time bidding machine facility 142, a tracking machine facility 144, an impression/click/action logs facility 148, and a real-time bidding logs facility 150.

In embodiments, the one or more databases providing data to the real-time bidding system 100A and to the learning machine facility 138 relating to ads, ad performance, or ad placement context, may include an agency database and/or an advertiser database 152. The agency database may include campaign descriptors, and may describe the channels, timelines, budgets, and other information, including historical information, relating to the use and distribution of advertisements. The agency data 152 may also include campaign and historic logs that may include the placement for each advertisement shown to users. The agency data 152 may also include one or more of the following: an identifier for the user, the web page context, time, price paid, ad message shown, and resulting user actions, or some other type of campaign or historic log data. The advertiser database may include business intelligence data, or some other type of data, which may describe dynamic and/or static marketing objectives, or may describe the operation of the advertiser 104. In an example, the amount of overstock of a given product (that the advertiser 104 has in its warehouses) may be described by the advertiser data 152. In another example, the data may describe purchases executed by costumers when interacting with the advertiser 104,

In embodiments, the one or more databases may include an historic event database. The historic event data 154, may be used to correlate the time of user events with other events happening in, for example, a region in which the user is located. In an example, response rates to certain types of advertisements may be correlated to stock market movements. The historic event data 154 may include, but is not limited to, weather data, events data, local news data, or some other type of data.

In embodiments, the one or more databases may include a user data 158, database. The user data 158, may include data may be internally sourced and/or provided by third parties that may contain personally linked information about advertising recipients. This information may associate users with preferences, or other indicators, which may be used to label, describe, or categorize the users.

In embodiments, the one or more databases may include a real-time event database. The real-time event data 160 may include data similar to historic data, but more current. The real-time event data 160 may include, but is not limited to, data that is current to the second, minute, hour, day, or some other measure of time. In an example, if the learning machine facility 138 finds a correlation between ad performance and historic stock market index values, the real-time stock market index value may be used to valuate advertisements by the real-time bidding machine facility 142.

In embodiments, the one or more databases may include a contextual database that may provide contextual data 162, associated with publisher's, publisher's content (e.g., a publisher's website), and the like. Contextual data 162, may include, but is not limited to, keywords found within the ad; an URL associated with prior placements of the ad, or some other type of contextual data 162, and may be stored as a categorization metadata relating to publisher's content. In an example, such categorization metadata may record that a first publisher's website is related to financial content, and a second publisher's content is predominantly sports-related.

In embodiments, the one or more databases may further include a third party/commercial database. A third party/commercial database may include data 164, relating to consumer transactions, such as point-of-sale scanner data obtained from retail transactions, or some other type of third party or commercial data.

In embodiments of the present invention, data from the one or more databases may be shared with the analytic facilities 114, of the real-time bidding system 100A through a data integration facility 134. In an example, the data integration facility 134 may provide data from the one or more databases to the analytics facilities of the real-time bidding system 100A for the purposes of evaluating a potential ad and/or ad placement. For example, the data integration facility 134, may combine, merge, analyze or integrate a plurality of data types received from the available databases (e.g., user data 158 and real-time event data 160). In an embodiment, a contextualizer may analyze web content to determine whether a web page contains content about sports, finance, or some other topic. This information may be used as an input to the analytics platform facility 114 in order to identify the relevant publishers and/or web pages where ads will appear.

In embodiments, the analytics facilities of the real-time bidding system 100A may receive an ad request via the advertising order sending and receiving facility 120. The ad request may come from an advertising agency 102, advertiser 104, ad network 108, ad exchange 110, and publisher 112 or some other party requesting advertising content. For example, the tracking machine facility 144 may receive the ad request via the advertising order sending and receiving facility 120, and provide a service that may include attaching an identifier, such as an ad tag using an ad tagging facility 118, to each ad order, and resulting ad placement. This ad tracking functionality may enable the real-time bidding system 100A to track, collect and analyze advertising performance data 130. For example an online display ad may be tagged using a tracking pixel. Once a pixel is served from the tracking machine facility 144, it may record the placement opportunity as well as the time and date of the opportunity. In another embodiment of the invention, the tracking machine facility 144 may record the ID of the ad requestor, the user, and other information that labels the user including, but not limited to, Internet Protocol (IP) address, context of an ad and/or ad placement, a user's history, geo-location information of the user, social behavior, inferred demographics or some other type of data Ad impressions, user clickthroughs, action logs, or some other type of data, may be produced by the tracking machine facility 144.

In embodiments, the recorded logs, and other data types, may be used by the learning machine facility 138 to improve and customize the targeting and valuation algorithms 140, as described herein. The learning machine facility 138 may create rules regarding advertisements that are performing well for a given client and may optimize the content of an advertising campaign based on the created rules. Further, in embodiments of the invention, the learning machine facility 138 may be used to develop targeting algorithms for the real-time bidding machine facility 142. The learning machine facility 138 may learn patterns, including Internet Protocol (IP) address, context of an ad and/or ad placement, URL of the ad placement website, a user's history, geo-location information of the user, social behavior, inferred demographics, or any other characteristic of the user or that can be linked to the user, ad concept, ad size, ad format, ad color, or any other characteristic of an ad or some other type of data, among others, that may be used to target and value ads and ad placement opportunities. In an embodiment of the invention, the learning patterns may be used to target ads. Further, the learning machine facility 138 may be coupled to one or more databases, as depicted in FIG. 1, from which it may obtain additional data needed to further optimize targeting and/or valuation algorithms 140.

In an embodiment of the invention, an advertiser 104 may place an “order” with instructions limiting where and when an ad may be placed. The order from the advertiser 104 may be received by the learning machine facilities or another element of the platform. The advertiser 104 may specify the criteria of ‘goodness’ for the ad campaign to be successful. Further, the tracking machine facility 144 may be used to measure the ‘goodness’ criteria. The advertiser 104 may also provide historic data associated with the ‘order’ in order to bootstrap the outcome of the analysis. Thus, based on data available from the one or more databases and the data provided by the advertiser 104, the learning machine facility 138 may develop customized targeting algorithms for the advertisement. The targeting algorithms may calculate an expected value of the advertisement under certain conditions (using, for example, real-time event data 160 as part of the modeling). The targeting algorithms may also seek to maximize the specified ‘goodness’ criteria. The targeting algorithms developed by the learning machine facility 138 may be received by the real-time bidding machine 142, which may wait for opportunities to place the advertisement. In an embodiment of the invention, the real-time bidding machine facility 142 may also receive an ad and/or bid request via the advertising order sending and receiving facility 120. The real-time bidding machine facility 142 may be considered a “real-time” facility since it may reply to an ad or bid request that is associated with a time constraint. The real-time bidding machine facility 142 may use a non-stateless method to calculate which advertising message to show, while the user waits for the system to decide. The real-time bidding machine facility 142 may perform the real-time calculation using algorithms provided by the learning machine facility 138, dynamically estimating an optimal bid value. In embodiments, an alternative real-time bidding machine facility 142 may have a stateless configuration to determine an advertisement to present.

The real-time bidding machine facility 142 may blend historical and real-time data to produce a valuation algorithm for calculating a real-time bid value to associate with an ad and/or ad placement opportunity. The real-time bidding machine facility 142 may calculate an expected value that combines information about the Internet Protocol (IP) address, context of an ad and/or ad placement, a user's history, geo-location information of the user, social behavior, inferred demographics or some other type of data. In embodiments, the real-time bidding machine facility 142 may use an opportunistic algorithm update by using tracking machine 144 or ad performance data to order and prioritize the algorithms based at least in part on the performance of each algorithm. The learning machine facility 138 may use and select from an open list of multiple, competing algorithms in the machine learning facility and real-time bidding facility. The real-time bidding machine 142 may use control systems theory to control the pricing and speed of delivery of a set of advertisements. Further, the real-time bidding machine facility 142 may use won and lost bid data to build user profiles. Also, the real-time bidding machine 142 may correlate expected values with current events in the ad recipient's geography. The real-time bidding machine facility 142 may trade ad buys across multiple exchanges and thus, treat multiple exchanges as a single source of inventory, selecting and buying ads based at least in part on the valuation that is modeled by the real-time bidding system 100A.

In embodiments, the real-time bidding system 100A may further include a real-time bidding log facility that may record a bid request received and a bid response sent by the real-time bidding machine facility 142. In an embodiment of the invention, the real-time bidding log may log additional data related to a user. In an example, the additional data may include the details of the websites the user may visit. These details may be used to derive user interests or browsing habits. Additionally, the real-time bidding log facility may record the rate of arrival of advertising placement opportunities from different ad channels. In an embodiment of the invention, the real-time bidding log facility may also be coupled to the learning machine facility 138.

In embodiments, the real-time bidding machine 142 may dynamically determine an anticipated economic valuation for each of the plurality of potential placements for an advertisement based at least in part on valuation algorithms 140 associated with the learning machine facility 138. In response to receiving a request to place an advertisement, the real-time bidding machine facility 142 may dynamically determine an anticipated economic valuation for each of the plurality of potential placements for the advertisement, and may select and decide whether to present the available placements based on the economic valuation to the one or more distribution service consumers.

In embodiments, the real-time bidding machine 142 may include altering a model for dynamically determining the economic valuation prior to processing a second request for a placement. The alteration of the model may be based at least in part on a valuation algorithm associated with the learning facility. In an embodiment of the invention, prior to selecting and presenting the one or more of the available placements, the behavior of an economic valuation model may be altered to produce a second set of valuations for each of the plurality of placements.

In embodiments, the valuation algorithms 140 may evaluate performance information relating to each of the plurality of ad placements. A dynamically variable economic valuation model may be used to determine the anticipated valuation. The valuation model may evaluate bid values in relation to the economic valuations for a plurality of placements. A step in bidding for the plurality of available placements and/or plurality of advertisements may be based on the economic valuation. In an exemplary case, the real-time bidding machine facility 142 may adopt the following sequence: At Step 1, the real-time bidding machine 142 may filter possible ads that are to be shown using the valuation algorithms 140. At Step 2, the real-time bidding machine facility 142 may check if the filtered ads have remaining budget funds, and may remove any ads from the list that do not have available budget funds from the list. At Step 3, the real-time bidding machine facility 142 may run an economic valuation algorithm for the ads in order to determine the economic value for each ad. At Step 4, the real-time bidding machine 142 may adjust the economic values by the opportunity cost of placing an ad. At Step 5, the real-time bidding machine facility 142 may select the ad with the highest economic value, after adjusting by the opportunity cost. At Step 6, the information about the first request, which may include information about the publisher 112 content of a request, may be used to update the dynamic algorithm before the second request is received and processed. Finally, at Step 7, the second ad may be processed in the same sequence as the first, with updates to the dynamic algorithm before the third ad is placed. In embodiments, a plurality of competing valuation algorithms 140 may be used at each step in selecting an ad to present. By tracking the advertising performance of the ad that eventually is placed, the competing algorithms may be evaluated in order to determine their relative performance and utility.

In an embodiment of the present invention, competing algorithms may be tested by dividing portions of data into separate training and validation sets. Each of the algorithms may be trained on a training set of data, and then validated (measured) for predictiveness against the validation set of data. Each bidding algorithm may be evaluated for its predictiveness against the validation set using metrics such as receiver operating characteristic (ROC) area, Lift, Precision/Recall, Return on Advertising Spend, other signal processing metrics, other machine learning metrics, other advertising metrics, or some other analytic method, statistical technique or tool. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention. Predictiveness of an algorithm may be measured by how well it predicts the likelihood that showing a particular advertisement to a particular consumer in a particular context is likely to influence a consumer to engage in a desirable action, such as purchasing one of the advertiser's products, engaging with the advertiser product, affecting the consumer perception about the advertiser's product, visiting a web page, or taking some other kind of action which is valued by the advertiser.

In an embodiment of the present invention, cross-validation may be used to improve the algorithm evaluation metrics. Cross-validation describes a methodology where a training set-validation set procedure for evaluating competing algorithms and/or models is repeated multiple times by changing the training and validation sets of data. Cross-validation techniques that may be used as part of the methods and systems described herein include, but are not limited to, repeated random sub-sampling validation, k-fold cross-validation, k×2 cross-validation, leave-one-out cross-validation, or some other type of cross-validation technique.

In embodiments, competing algorithms may be evaluated using the methods and systems as described herein, in real-time, in batch mode processing, or using some other periodic processing framework. In embodiments, competing algorithms may be evaluated online, such as using the Internet or some other networked platform, or the competing algorithms may be evaluated offline and made available to an online facility following evaluation. In a sample embodiment, one algorithm may be strictly better than all other algorithms, in terms of its predictiveness, and it may be chosen offline in the learning facility 138. In another sample embodiment, one algorithm from a set may be more predictive given a particular combination of variables, and more than one algorithm may be made available to the real-time bidding facility 142 and the selection of the best performing algorithm may take place in real-time, for example, by examining the attributes of a particular placement request, then determining which algorithm from the set of trained algorithms is most predictive for that particular set of attributes.

In embodiments, data corresponding to the valuation of an ad from the real-time bidding system 100A may be received by the advertising distribution service facility 122 and delivered to a consumer of the valuation data, such as an advertising agency 102, advertiser 104, ad network 108, ad exchange 110, publisher 112, or some other type of consumer. In another embodiment of the invention, the advertising distribution service facility 122 may be an ad server. The advertising distribution service facility 122 may distribute an output of the real-time bidding system 100A, such as a selected ad, to the one or more ad servers. In embodiments, the advertising distribution service facilities 122 may be coupled to the tracking machine facility 144. In another embodiment of the invention, the advertising distribution service facility 122 may be coupled to an ad display client 128. In embodiments, an ad display client 128 may be a mobile device, a PDA, cell phone, a computer, a communicator, a digital device, a digital display panel or some other type of device able to present advertisements.

In embodiments, an ad received at the ad display client 128 may include interactive data; for example, popping up of an offer on movie tickets. A user of the ad display client 128 may interact with the ad and may perform actions such as making a purchase, clicking an ad, filling out a form, or performing some other type of user action. The user actions may be recorded by the advertising performance data facility 130. In an embodiment, the advertising performance data facility 130 may be coupled to the one or more databases. In an example, the performance data facility may be coupled to the contextual database for updating the contextual database in real-time. In an embodiment, the updated information may be accessed by the real-time bidding system 100A for updating the valuation algorithms 140. In embodiments, the advertising performance data facility 130 may be coupled to the one or more distribution service consumers.

Data corresponding to the valuation of an ad from the analytics platform facility 114 may also be received by the advertising distribution service facility 122. In an embodiment of the invention, the advertising distribution service facility 122 may utilize the valuation data for reordering/rearranging/reorganizing the one or more ads. In another embodiment, the advertising distribution service facility 122 may utilize the valuation data for ranking ads based on predefined criteria. The predefined criteria may include, time of the day, location, and the like.

The advertising data distribution service facility 124 may also provide valuation data to the one or more consumers of ad valuation data. In embodiments, an advertising data distribution service facility 124 may sell the valuation data or may provide subscription of the valuation data to the one or more consumers of ad valuation data. In embodiments, the advertising distribution service facility 122 may provide the output from the real-time bidding system 100A or from the learning machine facility 138 to the one or more consumers of ad valuation data. The consumers of ad valuation data may include, without any limitation, advertising agencies 102/advertisers 104, an ad network 108, an ad exchange 110, a publisher 112, or some other type of ad valuation data customer. In an example, an advertising agency 102 may be a service business dedicated to creating, planning, and handling of advertisements for its clients. The ad agency 102 may be independent from the client and may provide an outside point of view to the effort of selling the client's products or services. Further, the ad agencies 102 may be of different types, including without any limitation, limited-service advertising agencies, specialist advertising agencies, in-house advertising agencies, interactive agencies, search engine agencies, social media agencies, healthcare communications agencies, medical education agencies, or some other type of agency. Further, in examples, an ad network 108 may be an entity that may connect advertisers 104 to websites that may want to host their advertisements. Ad networks 108 may include, without any limitation, vertical networks, blind networks, and targeted networks. The Ad networks 108 may also be classified as first-tier and second-tier networks. The first-tier advertising networks may have a large number of their own advertisers 104 and publishers, they may have high quality traffic, and they may serve ads and traffic to second-tier networks. The second-tier advertising networks may have some of their own advertisers 104 and publishers, but their main source of revenue may come from syndicating ads from other advertising networks. An ad exchange 110 network may include information related to attributes of ad inventory such as price of ad impression, number of advertisers 104 in a specific product or services category, legacy data about the highest and the lowest bid for a specific period, ad success (user click the ad impression), and the like. The advertisers 104 may be able to use this data as part of their decision-making For example, the stored information may depict the success rate for a particular publisher 112. In addition, advertisers 104 may have an option of choosing one or more models for making financial transactions. For example, a cost-per-transaction pricing structure may be adopted by the advertiser 104. Likewise, in another example, advertisers 104 may have an option to pay cost-per-click. The ad exchange 110 may implement algorithms, which may allow the publisher 112 to price ad impressions during bidding in real-time.

In embodiments, a real-time bidding system 100A for advertising messages delivery may be a composition of machines intended for buying opportunities to place advertising messages across multiple delivery channels. The system may provide active feedback in order to automatically fine-tune and target the channels used to present the advertising messages, as well as to select what advertising messages to show in each placement opportunity, and the associated costs over time. In embodiments, the system may be composed of interconnected machines, including but not limited to: (1) a learning machine facility 138, (2) a real-time bidding machine 142, and (3) a tracking machine 144. Two of the machines may produce logs, which may be internally used by the learning machine facility 138. In embodiments, the inputs to the system may be from both real-time and non-real time sources. Historical data may be combined with real-time data to fine-tune pricing and delivery instructions for advertising campaigns.

In embodiments, a real-time bidding system 100A for advertising messages delivery may include external machines and services. External machines and services may include, but are not limited to, agencies 102, advertisers 104, agency data 152, such as campaign descriptors and historic logs, advertiser data 152, key performance indicators, historic event data 154, user data 158, a contextualizer service 132, real-time event data 160, an advertising distribution service 122, an advertising recipient, or some other type of external machine and/or service.

In embodiments, agencies and/or advertisers 104 may provide historical ad data, and may be beneficiaries of the real-time bidding system 100A.

In embodiments, agency data 152, such as campaign descriptors, may describe the channels, times, budgets, and other information that may be allowed for diffusion of advertising messages.

In embodiments, agency data 152, such as campaign and historic logs may describe the placement for each advertising message show to a user, including one or more of the following: an identifier for the user, the channel, time, price paid, ad message shown, and user resulting user actions, or some other type of campaign or historic log data. Additional logs may also record spontaneous user actions, for example a user action that is not directly traceable to an advertising impression, or some other type of spontaneous user action.

In embodiments, advertiser data 152 may consist of business intelligence data, or some other type of data, that describes dynamic and/or static marketing objectives. For example, the amount of overstock of a given product that the advertiser 104 has in its warehouses may be described by the data.

In embodiments, key performance indicators may include a set of parameters that expresses the ‘goodness’ for each given user action. For example, a product activation may be valued at $X, and a product configuration may be valued at $Y.

In embodiments, historic event data 154 may be used by the real-time bidding system 100A to correlate the time of user events with other events happening in their region. For example, response rates to certain types of advertisements may be correlated to stock market movements. Historic event data 154 may include, but is not limited to weather data, events data, local news data, or some other type of data.

In embodiments, user data 158 may include data provided by third parties that contains personally linked information about advertising recipients. This information may show users preferences, or other indicators, that label or describe the users.

In embodiments, a contextualizer service 132 may identify the contextual category of a medium for advertising. For example, a contextualizer may analyze web content to determine whether a web page contains content about sports, finance, or some other topic. This information may be used as an input to the learning system 138, to refine which types of pages on which ads will appear.

In embodiments, real-time event data 160 may include data similar to historic data, but that is more current. Real-time event data 160 may include, but is not limited to data that is current to the second, minute, hour, day, or some other measure of time. For example, if the learning machine facility 138 finds a correlation between ad performance and historic stock market index values, the real-time stock market index value may be used to value advertisements by the real-time bidding machine 142.

In embodiments, an advertising distribution service 122 may include, but is not limited to ad networks 108, ad exchanges 110, sell-side optimizers, or some other type of advertising distribution service 122.

In embodiments, an advertising recipient may include a person who receives an advertising message. Advertising content may be specifically requested (“pulled”) as part of or attached to content requested by an advertising recipient, or “pushed” over the network by, for example, an advertising distribution service 122. Some non-limiting examples of modes of receiving advertising include the Internet, mobile phone display screens, radio transmissions, television transmissions, electronic bulletin boards, printed media, and cinematographic projections.

In embodiments, a real-time bidding system 100A for advertising messages delivery may include internal machines and services. Internal machines and services may include, but are not limited to, a real-time bidding machine 142, a tracking machine 144, a real-time bidding log, impression, click and action logs, a learning machine facility 138, or some other type of internal machine and/or service.

In embodiments, a real-time bidding machine 142 may receive a bid request message from an advertising distribution service 122. A real-time bidding machine 142 may be considered a “real-time” system, since it may reply to a bid request that is associated with a time constraint. The real-time bidding machine 142 may use a non-stateless method to calculate which advertising message to show, while the user is waiting for the system to decide. The system may perform the real-time calculation using algorithms provided by the learning machine facility 138, dynamically estimating an optimal bid value. In embodiments, an alternative system may have a stateless configuration to determine an advertisement to present.

In embodiments, a tracking machine 144 may provide a service that will attach tracking IDs to each advertisement. For example, an online display ad may be followed by a pixel. Once a pixel is served from the tracking machine 144, it may record the placement opportunity as well as the time and date; additionally, the machine may record the ID of the user, and other information that labels the user, including but not limited to IP address, geographic location, or some other type of data.

In embodiments, a real-time bidding log may record a bid request received and a bid response sent by the real-time bidding machine 142. This log may contain additional data about which sites a user has visited that could be used to derive user interests or browsing habits. Additionally, this log may record the rate of arrival of advertising placement opportunities from different channels.

In embodiments, impression, click and action logs may be records that are produced by the tracking system, which can be used by the learning machine facility 138.

In embodiments, a learning machine facility 138 may be used to develop targeting algorithms for the real-time bidding machine 142. The learning machine facility 138 may learn patterns, including social behavior, inferred demographics, among others, that may be used to target online ads.

In an example, an advertiser 104 may place an “order” with instructions limiting where and when an ad may be placed. The order may be received by the learning machine facility 138. The advertiser 104 may specify the criteria of ‘goodness’ for the campaign to be successful. Such ‘goodness’ criteria may be measurable using the tracking machine 144. The advertiser 104 may provide historic data to bootstrap the system. Based on available data, the learning system 138 may develop customized targeting algorithms for the advertisement. The algorithms may calculate an expected value of the advertisement given certain conditions, and seek to maximize the specified ‘goodness’ criteria. Algorithms may be received by the real-time bidding machine 142, which may wait for opportunities to place the advertisement. Bid requests may be received by the real-time bidding machine 142. Each one may be evaluated for its value for each advertiser 104, using the received algorithms. Bid responses may be sent for ads that have an attractive value. Lower values may be bid if estimated appropriate. The bid response may request that an ad be placed at a particular price. Ads may be tagged with a tracking system, such as a pixel displayed in a browser. The tracking machine 144 may log ad impressions, user clicks, and user actions. And/or other data. The tracking machine logs may be sent to the learning system 138, which may use the ‘goodness criteria,’ and decide which algorithms to improve, and further customize them. This process may be iterative. The system may also correlate expected values with current events in the ad recipient's geo-region.

In embodiments, a real-time bidding machine 142 may dynamically update targeting algorithms.

In embodiments, a real-time bidding machine 142 may blend historical and real-time data to produce an algorithm for calculating a real-time bid value.

In embodiments, a real-time bidding machine 142 may calculate an expected value that combines information about the context of an ad placement, a user's history and geo-location information, and the ad itself, or some other type of data, to calculate an expected value of showing a particular advertisement at a given time.

In embodiments, a real-time bidding machine 142 may use algorithms rather than targeting “buckets.”

In embodiments, a real-time bidding machine 142 may use an opportunistic algorithm update, by using tracking machine facility 144 feedback to prioritize the worst performing algorithms.

In embodiments, a real-time bidding machine 142 may use an open list of multiple, competing algorithms in the learning system 138 and real-time bidding system 100A.

In embodiments, a real-time bidding machine 142 may use control systems theory to control the pricing and speed of delivery of a set of advertisements.

In embodiments, a real-time bidding machine 142 may use won and lost bid data to build user profiles.

As shown in FIG. 1B, in embodiments, a real-time bidding machine may trade ad buys across multiple exchanges 100B. Treating multiple exchanges as a single source of inventory.

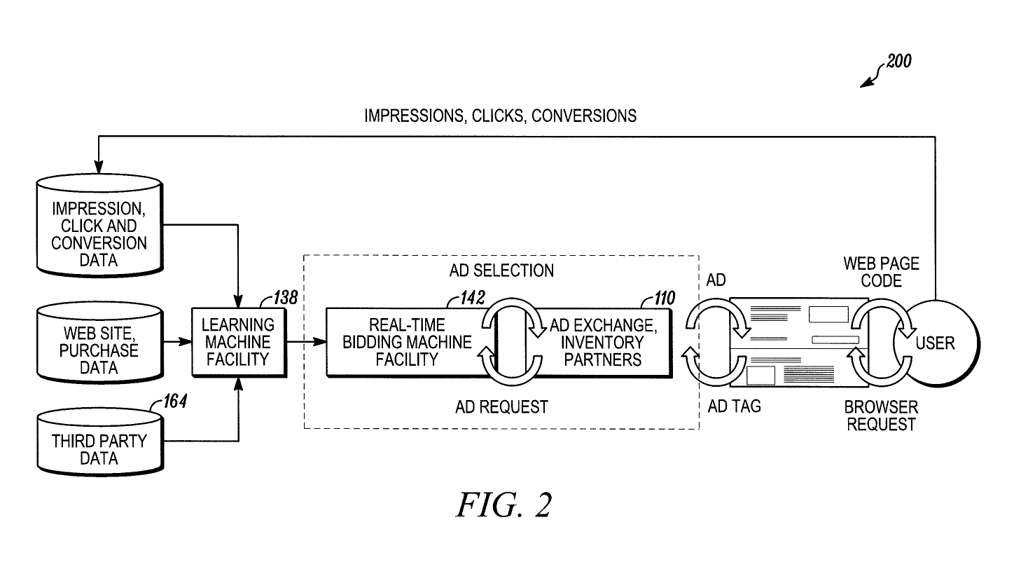

Referring to FIG. 2, the analytic algorithms of the real-time bidding system may be used to optimize the management of bids associated with advertisements and advertisement impressions, conversions, or some other type of ad-user interaction 200. In embodiments, the learning system embodied, for example, by the learning machine 138 may create rules regarding which advertisements are performing well for a given client and optimize the content mix of an advertising campaign based at least in part on the rules. In an example, a digital media user's behavior, such as an advertisement clickthrough, impression, webpage visit, transaction or purchase, or third party data associated with the user may be associated with, and used by the learning system of the real-time bidding system. The real-time bidding system may use the output of the learning system (e.g., rules and algorithms) to pair a request for an advertisement with an advertisement selection that conforms to the rules and/or algorithms created by the learning machine. A selected advertisement may come from an ad exchange, inventory partner, or some other source of advertising content. The selected advertisement may then be associated with an ad tag, as described herein, and sent to the digital media user for presentation, such as on a webpage. The ad tag may then be tracked and future impressions, clickthroughs, and the like recorded in databases associated with the real-time bidding system. The rules and algorithms may then be further optimized by the learning machine based at least in part on new interactions (or lack thereof) between the selected advertisement and the digital media user.

In embodiments, a computer program product embodied in a computer readable medium that, when executing on one or more computers, may dynamically determine an anticipated economic valuation for each of a plurality of potential placements for an advertisement based at least in part on receiving a request to place an advertisement for a publisher. In response to receiving a request to place an advertisement for a publisher, the method and system of the present invention may dynamically determine an anticipated economic valuation for each of a plurality of potential placements for the advertisement, and/or plurality of advertisements, and select and decide whether to present to the publisher at least one of the plurality of available placements and/or plurality of advertisements based on the economic valuation.

In embodiments, the method and system enabled by the computer program may comprise altering a model for dynamically determining the economic valuation prior to processing a second request for a placement. Alteration of the model may be based at least in part on machine learning.

In embodiments, prior to selecting and presenting at least one of the plurality of available placements, and/or plurality of advertisements, the behavior of an economic valuation model may be altered to produce a second set of valuations for each of the plurality of placements, wherein the selecting and the presenting steps are based at least in part on the second set of valuations. The request for the placement may be a time limited request.

In embodiments, the economic valuation model may evaluate performance information relating to each of the plurality of advertisement placements.

In embodiments, a dynamically variable economic valuation model may be used to determine the anticipated economic valuation. The dynamically variable economic valuation model may evaluate bid values in relation to economic valuations for a plurality of placements. A step of bidding for at least one of the plurality of available placements, and/or plurality of advertisements, may be based on the economic valuation.

Referring still to FIG. 2, the real-time bidding system may contain an algorithm fitting the description above 200. Given a plurality of possible ads to show the real-time bidding system may follow the following exemplary sequence: 1) All possible ads may be filtered to show using targeting rules, and an output a listed ads may be shown; 2) the system may check if possible ads have remaining budget funds, and may remove those ads that do not have available budget funds from the list; 3) the system may run an economic valuation dynamic algorithm for the ads in order to determine the economic value for each ad; 4) the values may be adjusted by the opportunity cost of placing an ad on a given site, instead of alternative sites. 5) the ad with the highest value may be selected, after adjusting by the opportunity cost; 6) Information about the first request, which may include information about the publisher content of a request, may be used to update the dynamic algorithm before the second request is received and processed. This information may be used to determine whether or not a particular type of publisher content is available frequently or infrequently, and 7) the second ad may be processed in the same sequence as the first, with the updates to the dynamic algorithm before the third ad is placed.

In embodiments, the dynamic algorithm may be analogous to an algorithm used in airplane flight control systems, which adjust for atmospheric conditions as they change, or an automobile cruise control system, which dynamically adjusts the gas pedal positions as wind drag changes or the automobile climbs or descends a hill.

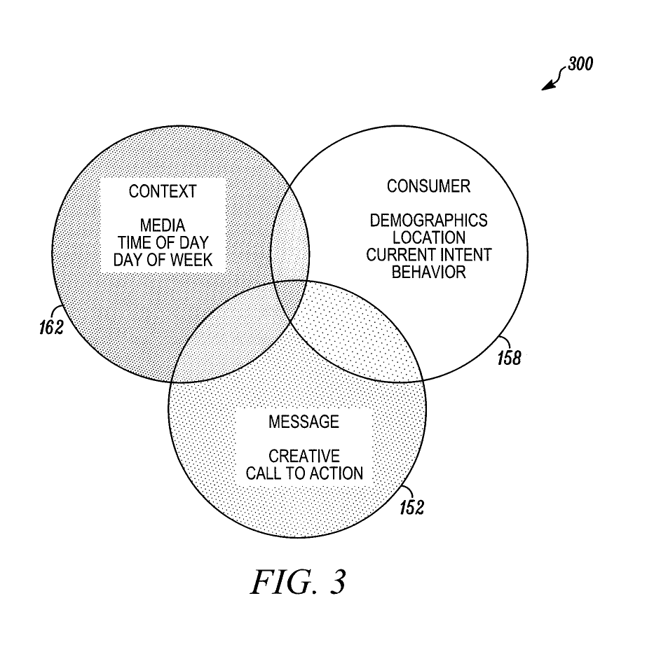

Referring to FIG. 3, data relating to context, the consumer (i.e., the digital media user), and the message/advertisement may be used to predict the success of an advertisement based at least in part on specified key performance indicators 300. Contextual data may include data relating to the type of media, the time of day or week, or some other type of contextual data. Data relating to a consumer, or digital media user, may include demographics, geographic data, and data relating to consumer intent or behavior, or some other type of consumer data. Data relating to the message and/or advertisement may include data associated with the creative content of the message/advertisement, the intention or call to action embodied in the message/advertisement, or some other type of data.

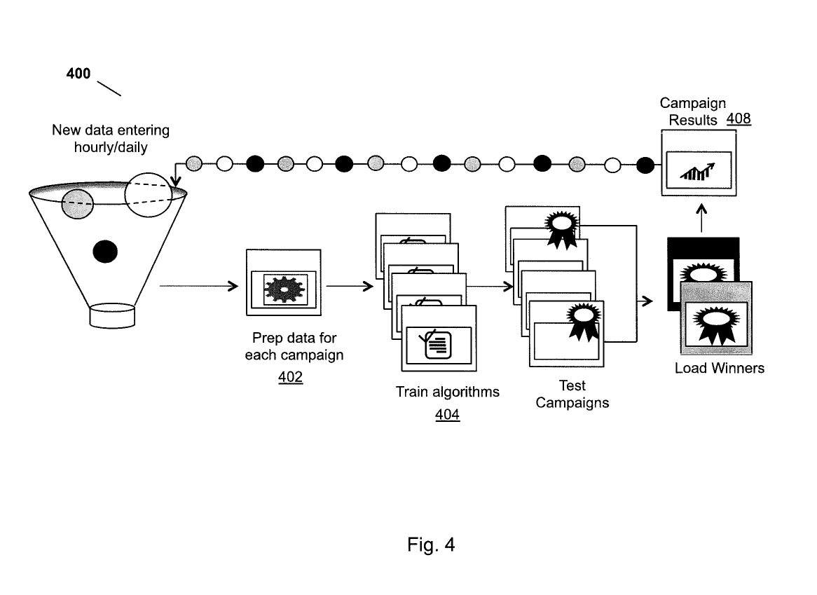

As depicted in FIG. 4, the real-time bidding system may be used to produce advertising campaign-specific models and algorithms that are continuously produced, tested, and run using data associated with campaign results (e.g., clickthroughs, conversions, transactions, and the like) as they become available in real-time 400. In embodiments, multiple models may be tested using preparatory datasets to design sample advertising campaigns. The multiple models may be run against multiple training algorithms that embody specified objectives, such as key performance indicators. Advertising content that performs well against the algorithms may be retained and presented to a plurality of digital media users. Additional data may be collected based at least in part on the interactions of the plurality of digital media users and the selected advertising content, and this data may be used to optimize the algorithms and select new or different advertising content for presentation to the plurality of digital media users.

Still referring to FIG. 4, in embodiments, a computer program product embodied in a computer readable medium that, when executing on one or more computers, may deploy an economic valuation model that may be refined through machine learning to evaluate information relating to a plurality of available placements, and/or plurality of advertisements, to predict an economic valuation for each of the plurality of placements 400. At least one of the plurality of available placements, and/or plurality of advertisements, may be selected and presented to the publisher based at least in part on the economic valuation.

In embodiments, data may be taken from various formats, including but not limited to information that is not about advertisements, such as successful market demographics data, and the like. This may include specific data streams, translating data into a neutral format, specific machine learning techniques, or some other data type or technique. In embodiments, the learning system may perform an auditing and/or supervisory function, including but not limited to optimizing the methods and systems as described herein. In embodiments, the learning system may learn from multiple data sources, and base optimization of the methods and systems as described herein based at least in part on the multiple data sources.

In embodiments, the methods and systems as described herein may be used in Internet-based applications, mobile applications, fixed-line applications (e.g., cable media), or some other type of digital application.

In embodiments, the methods and systems as described herein may be used in a plurality of addressable advertising media, including but not limited to set top boxes, digital billboards, radio ads, or some other type of addressable advertising media.

Examples of machine learning algorithms may include, but are not limited to, Naïve Bayes, Bayes Net, Support Vector Machines, Logistic Regression, Neural Networks, and Decision Trees. These algorithms may be used to produce classifiers, which are algorithms that classify whether or not an advertisement is likely to produce an action or not. In their basic form, they return a “yes” or “no” answer and a score indicated the strength of certainty of the classifier. When calibration techniques are applied, they return a probability estimate of the likelihood of a prediction to be correct. They can also return what specific advertising is most likely to produce an action or which characteristics describe advertisings most likely to produce an action. These characteristics can include advertisings concept, advertisings size, advertisings color, advertisings text, or any other characteristic of an advertisement. Furthermore, they can also return what version of the advertiser website is most likely to create an action or what characteristics describe the version of the advertiser website most likely to produce an action. These characteristics can include website concept, products presented, colors, images, prices, text, or any other characteristic of the website. In embodiments, a computer implemented method of the present invention may comprise applying a plurality of algorithms to predict performance of online advertising placements, and tracking performance of the plurality of algorithms under a variety of market conditions. Preferred performance conditions for a type of algorithm may be determined, and market conditions tracked, and an algorithm may be selected for predicting performance of advertising placements based at least in part on current market conditions. In embodiments, the plurality of algorithms may include three algorithms.

In embodiments, a computer program product embodied in a computer readable medium that, when executing on one or more computers, may predict, using a primary model, the economic valuation of each of a plurality of available web publishable advertisement placements based in part on past performance and prices of similar advertisement placements. The economic valuation of each of the plurality of web publishable advertisement placements may be predicted, through a second model, and the valuations produced by the primary model and the second model may be compared to determine a preference between the primary model and the second model. In embodiments, the primary model may be an active model responding to purchase requests. The purchase requested may be a time limited purchase request. In embodiments, the second model may replace the primary model as the active model responding to purchase requests. The replacement may be based at least in part on a prediction that the second model will perform better than the primary model under the current market conditions.

In embodiments, a computer implemented method of the present invention may apply a plurality of algorithms to predict performance of online advertising placements, track performance of the plurality of algorithms under a variety of market conditions, and determine preferred performance conditions for a type of algorithm. Market conditions may be tracked, and an algorithm for predicting performance of advertising placements may be refined based at least in part on current market conditions.

In embodiments, a computer implemented method of the present invention may monitor a set of algorithms that are each predicting purchase price value of a set of advertisements and selecting the best algorithm from the set of algorithms based at least in part on a current market condition.

Referring again to FIG. 4, new data may be entered into a sorting mechanism (depicted by a funnel in FIG. 4) 400. This data may be prepared for machine learning training by labeling each ad impression with an indicator of whether or not it leads to a click or action. Alternative machine learning algorithms may be trained on the labeled data. A portion of the labeled may be saved for a testing phase. This testing portion may be used to measure the prediction performance of each alternative algorithm. Algorithms which are most successful in predicting the outcome of the hold-out training data set may be forwarded to the real-time decision system.

In embodiments, a computer program product embodied in a computer readable medium that, when executing on one or more computers, may deploy a plurality of competing economic valuation models, in response to receiving to place an advertisement for a publisher, to predict an economic valuation for each of the plurality of advertisement placements. The valuations produced by each of the plurality of competing economic valuation models may be evaluated to select one of the models for a current valuation of an advertising placement. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

In embodiments, a computer program product embodied in a computer readable medium that, when executing on one or more computers, may deploy a plurality of competing economic valuation models, in response to receiving a request to place an advertisement, to evaluate information relating to a plurality of available advertisement placements. The economic valuation models may be used to predict an economic valuation for each of the plurality of advertisement placements. The valuations produced by each of the plurality of competing economic valuation models may be evaluated to select one of the models for future valuations. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

In embodiments, data may be evaluated to determine if it supports a winning algorithm in a learning system. The incremental value of buying additional data may be determined and auditing and testing of data samples may be used to determine whether the data increases the effectiveness of prediction. For example, the system may use data derived from an ad server log, combined with demographical information, to derive a valuation model, with a certain level of accuracy. Such a model may enable the acquisition of online advertising ads, for the benefit of an appliance manufacturer, below the market price. The addition of an additional data source, such as a list of consumers that have expressed their interest in buying a specific appliance, may increase the accuracy of the model, and as a consequence the benefit to the appliance manufacturer. It is stated that the increased benefit received would be linked to the addition of the new data source, and hence, such data source may be assigned a value linked to the incremental benefit. Although this example presents a case of online advertising, it should be appreciated by one skilled in the art that the application can be generalized to advertising through different channels, using data sources of different types, as well as models to predict economic value or pricing for advertising.

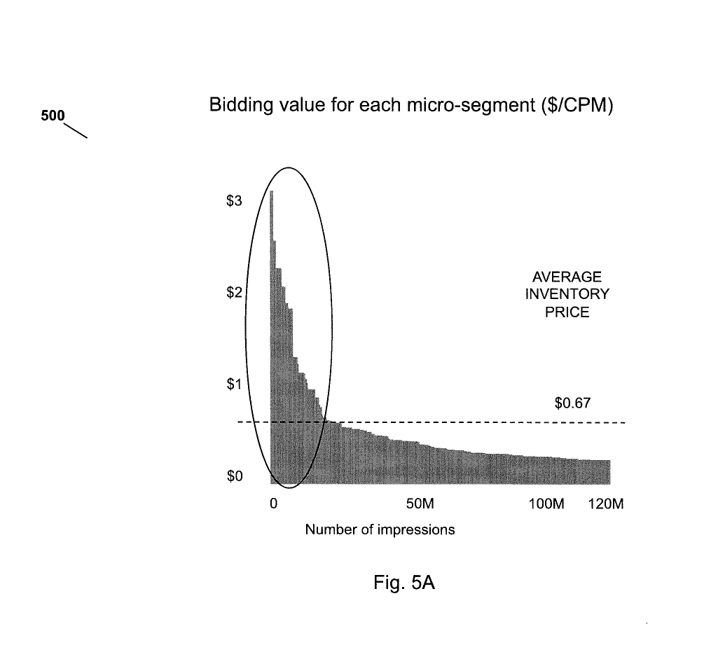

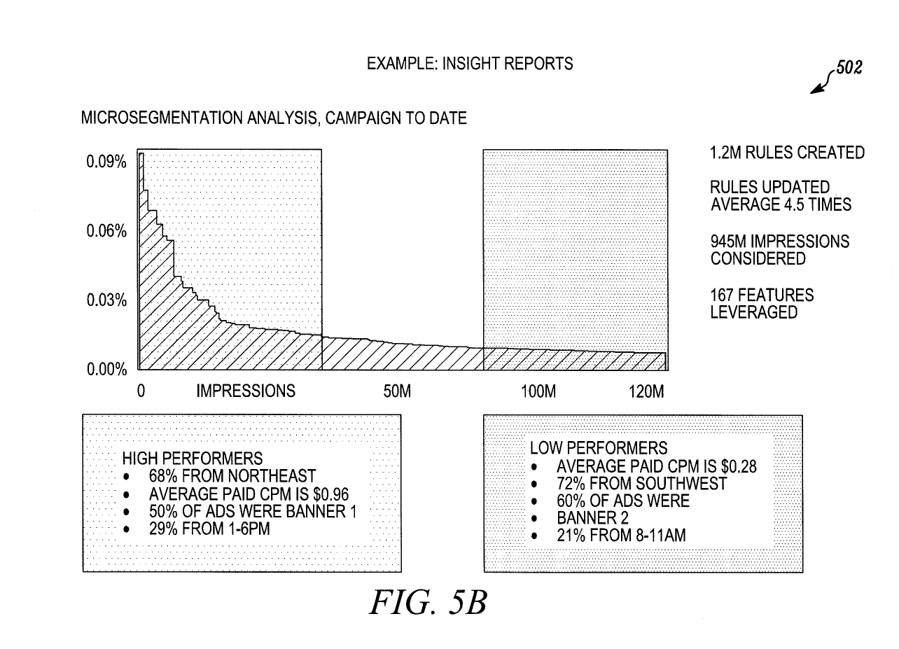

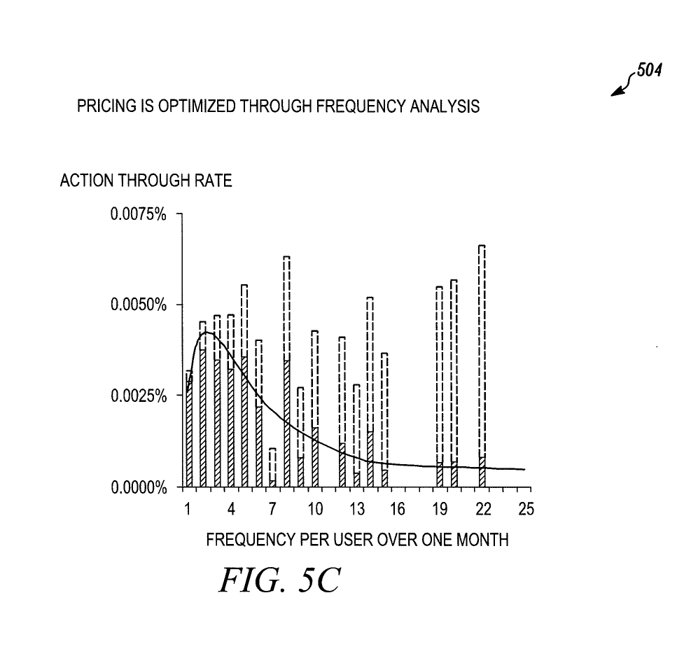

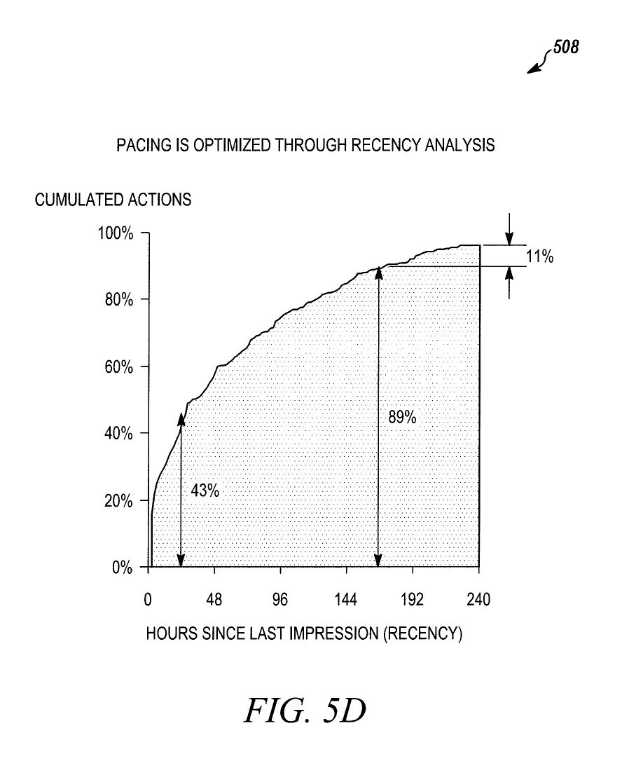

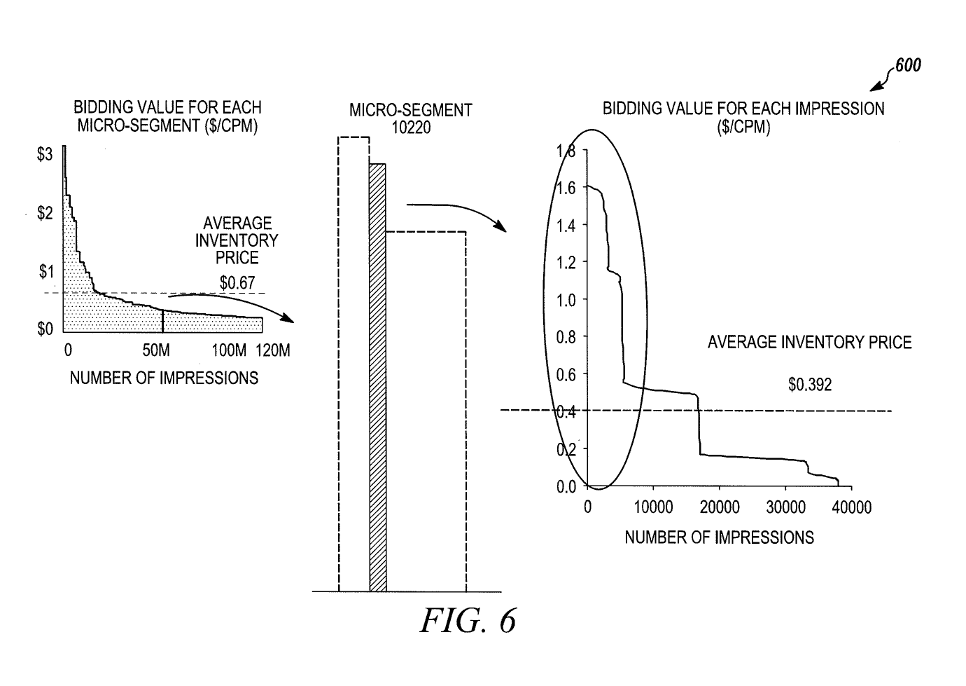

As depicted in FIGS. 5A and 5B, an advertisement inventory may be divided into many segments, or micro-segments (500, 502). The real-time bidding system may produce and continuously revise algorithms, for example by using the learning machine, based at least in part on data received on the performance of the advertisements in the inventory and its micro-segments (e.g., the number of impressions or conversions associated with each advertisement). Based at least in part on the learning system's algorithms, the real-time bidding system may produce a bid value that is thought to be “fair” relative to the advertising performance data. This bid value data may, in turn, be used to determine an average bid value to associate with advertisements located in the inventory. In embodiments, each micro-segment may be associated with a rule, algorithm, or set of rules and/or algorithms, a price-to-paid, and/or a budget. Rules may be used to buy advertising placement opportunities in groups of one or more opportunities. The size of the group of placement opportunities may be determined by the budget allocated to the rule. Rules may be transmitted to sellers of advertising placement opportunities through a server-to-server interface, through other electronic communication channel, including phone and fax, through a paper based order, through a verbal communication or any other way to convey an order to buy advertising placement opportunities. FIG. 5C depicts the use of frequency analysis for the purpose of pricing optimization 504. FIG. 5D depicts how pacing may be optimized through recency analysis within the real-time bidding system 508. Referring now to FIG. 6, the real-time bidding system may enable the automated analysis of an advertising inventory down to a nano-segment level (e.g., a bidding value for each impression) in order to identify valuable segments (i.e., advertisements) of an otherwise low-value advertisement inventory 600. The real-time bidding system may produce and continuously revise algorithms, for example by using the learning machine, based at least in part on data received on the performance of the advertisements in the nano-segment of the advertising inventory (e.g., the number of impressions associated with each advertisement). Based at least in part on the learning system's algorithms, the real-time bidding system may produce a bid value that is thought to be “fair” relative to the advertisement(s) in the nano-segment, based at least in part on the performance data. In embodiments, the average bid price associated with the nano-segment may be adjusted based on other criteria, for example the number of impressions associated with the advertisement. In embodiments, each nano-segment may be associated with a rule, algorithm, or set of rules and/or algorithms.

In embodiments, a computer program product embodied in a computer readable medium that, when executing on one or more computers, may predict a purchase price for each of a plurality of available web publishable advertisement placements based at least in part on performance information and past bid prices for each of the plurality of advertisement placements. The purchase price for each of the plurality of advertisements may be tracked and predicted to determine a pricing trend.

In embodiments, the pricing trend may include a prediction of whether the valuation is going to change in the future.

In embodiments, a computer program product embodied in a computer readable medium that, when executing on one or more computers, may predict an economic valuation for each of a plurality of available web publishable advertisement placements based at least in part on performance information and past bid prices for each of the plurality of advertisement placements. Economic valuations for each of the plurality of advertisements may be tracked and predicted to determine a pricing trend.

In an example, the system may present bids for buying ads in an auction, expecting a fraction of them to be successful, and be awarded the ads for which it sends bids. As the system operates, the fraction of bids that is successful might fall below the expected goal. Such behavior can happen for the universe of available ads or for a subset of them. The price trend predicting algorithm may estimate what correction should be done to the bid price, so that, the fraction of ads successfully bought becomes closer to the intended goal, and may finally reach the intended goal.

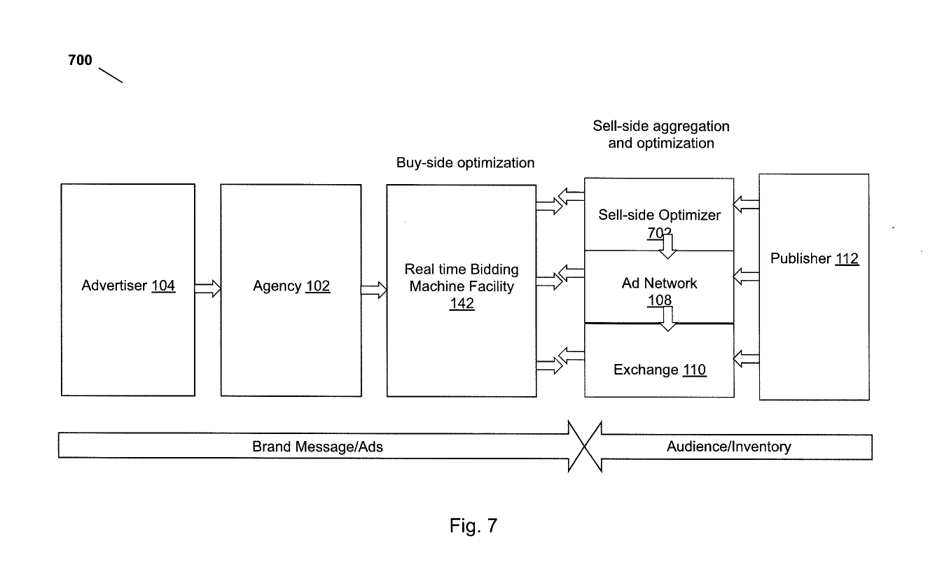

As depicted in FIG. 7, the real-time bidding method and system as described herein may be integrated, associated, and/or affiliated with a plurality of organizations and organization types, including but not limited to advertisers and advertising agencies 700. The real-time bidding system may perform buy-side optimization using the learning algorithms and techniques, as described herein, to optimize the selection of advertisements from sell-side aggregators, such as sell-side optimizers, ad networks, and/or exchanges, that receive advertisements from content publishers. This may optimize the pairing of messages and advertisements that are available within the inventories with digital media users. Advertising agencies may include Internet-based advertising companies, advertising sellers, such as organizations that sell advertisement impressions that display to a digital media user, and/or advertising buyers. Advertisers and advertising agencies may provide the real-time bidding system advertising campaign descriptors. A campaign descriptor may include, but is not limited to, a channel, time, budget, or some other type of campaign descriptor data. In embodiments, advertising agencydata may include historic logs that describe the placement of each advertisement and user impression, conversion, and the like, including, but not limited to an identifier associated with a user, a channel, time, price paid, advertisement shown, resulting user actions, or some other type of historic data relating to the advertisement and/or impression. Historic logs may also include data relating to spontaneous user actions. In embodiments, advertiser data utilized by the real-time bidding system may include, but is not limited to, metadata relating to the subject matter of an advertisement, for example, inventory levels of a product that is the subject of the advertisement. Valuation, bid amounts, and the like may be optimized according to this and other metadata. Valuation, bid amounts, and the like may be optimized according to key performance indicators.

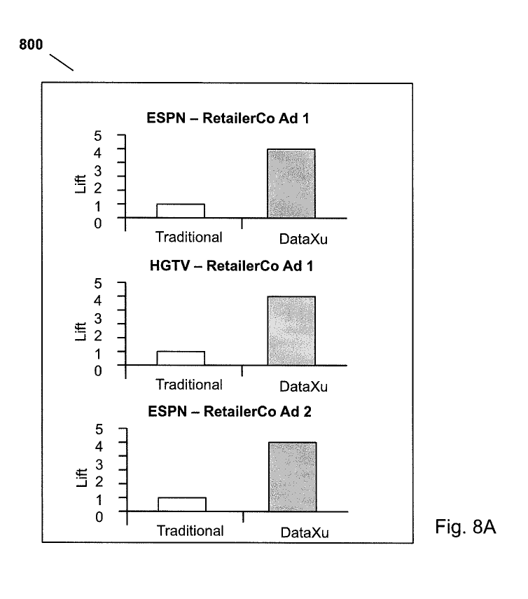

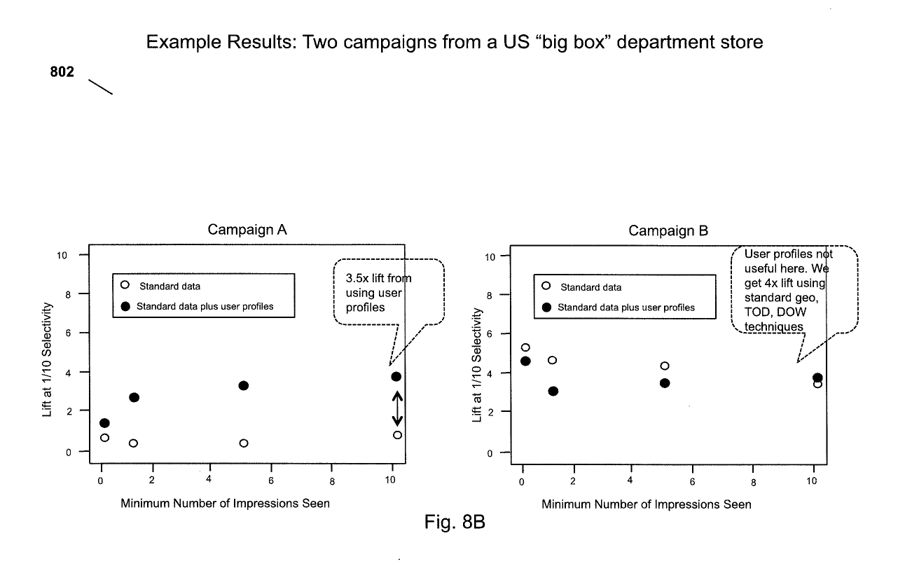

FIGS. 8A and 8B depicts a hypothetical case studies using a real-time bidding method and system (800, 802). In embodiments, the learning system may create rules and algorithms, as described herein, using training data sets, such as that derived from a prior retailer advertising campaign. The training dataset may include a record of prior impressions, conversions, actions, clickthroughs and the like performed by a plurality of digital media users with the advertisements that were included in the prior campaign. The learning system may then identify a subset of advertising content from the prior campaign that was relatively more successful that other of the advertisements in the campaign, and recommend this advertising content for future use on the basis of its higher expected value.

In embodiments, a computer program product embodied in a computer readable medium that, when executing on one or more computers, may deploy an economic valuation model, in response to receiving a request to place an advertisement, in order to evaluate information relating to a plurality of available advertisement placements. The economic valuation model may be used to predict an economic valuation or the pricing for bids for each of the plurality of advertisement placements. A hypothesis as to a market opportunity may be determined, and the economic valuation model may be updated in response to the hypothesized market opportunity.

In an example, the system may find every few seconds, a data set or identify changes to the model that improves the accuracy of the valuation model used to predict economic value of ads. The system may have limitations on its ability to replace the valuation model on its whole, at the same rate as new data or changes to the model are created. As a consequence it may be beneficial to select which parts are less effective at providing economic valuation. The opportunistic updating component may select what is the order and priority for replacing sections of the valuation model. Such prioritization may be based on the economic valuation of the section to replace versus the new section to incorporate. As a result the system may create a prioritized set of instructions as to what data or sections of the model to add to the valuation system and in what order to do so.

In embodiments, the method and system of the present invention may split an advertising campaign, and compare the performance of a first set from the campaign using the methods and systems as described herein with a second set from the campaign not using the methods and systems. The analytic comparison may show the lift and charge based on the lift between the first set and the second set (e.g., third party campaign).

In an example, the system may separate a fraction of ads for creating a baseline sample on which the system is not applied, and thus, its benefits may not be delivered. Such process may be automatic. Such separation may be done by a random selection, across the universe of available ads, or to a randomly selected panel of users. The remaining ads that do not belong to the baseline sample may be placed using the system.

In embodiments, as the ad campaign presents some objectives that are possible to measure, and the greater the benefit, the better is the campaign judged to be, it stands to believe an advertiser is willing to pay a premium for ad campaigns that deliver increased benefits.

In embodiments, the pricing model may calculate the difference between the benefit created by ads placed using the system and those placed without the system, as on the baseline sample. The system benefit is such net difference. The price charged to the advertiser may be a fraction of the system benefit.

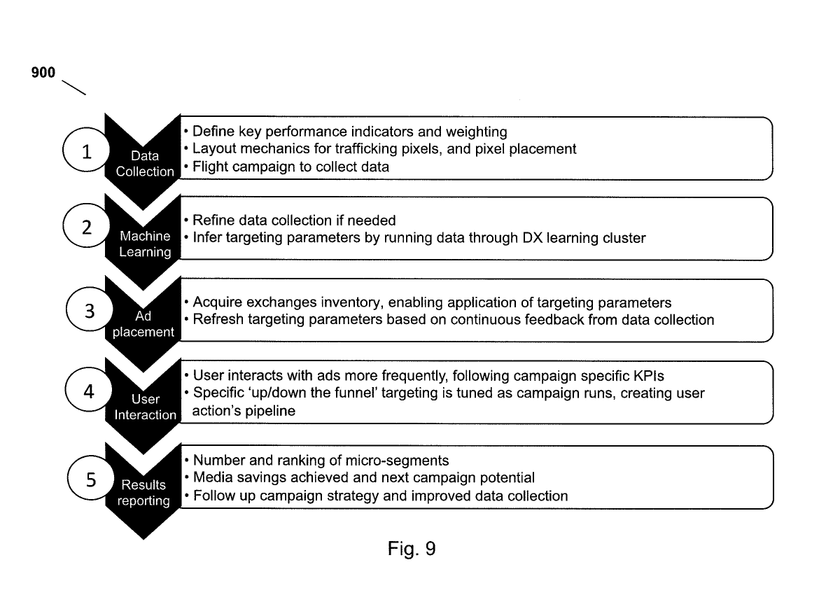

FIG. 9 depicts a simplified flow chart summarizing key steps that may be involved in using a real-time bidding method and system 900.

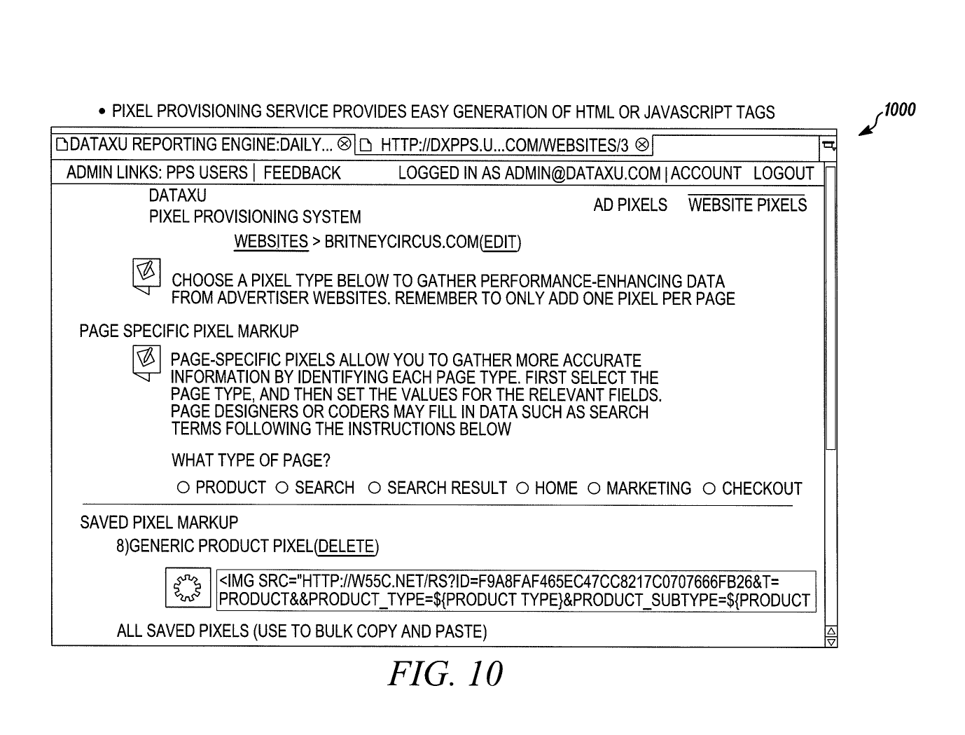

FIG. 10 depicts an exemplary embodiment of a user interface for a pixel provisioning system that may be associated with the real-time bidding system 1000.

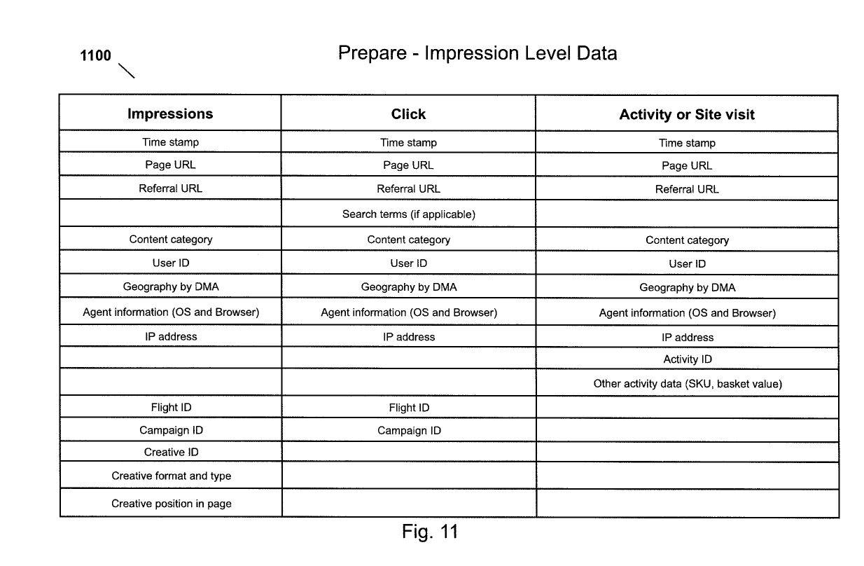

FIG. 11 depicts an exemplary embodiment of impression level data that may be associated with the real-time bidding system 1100.

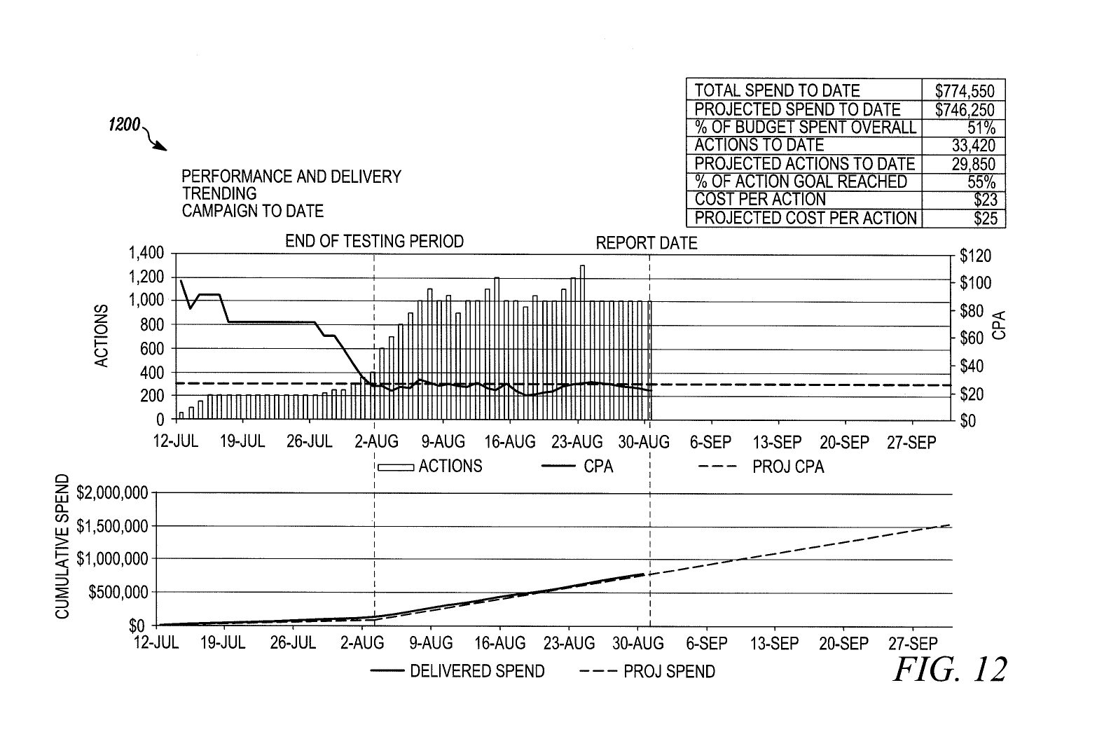

FIG. 12 depicts a hypothetical advertising campaign performance report 1200.

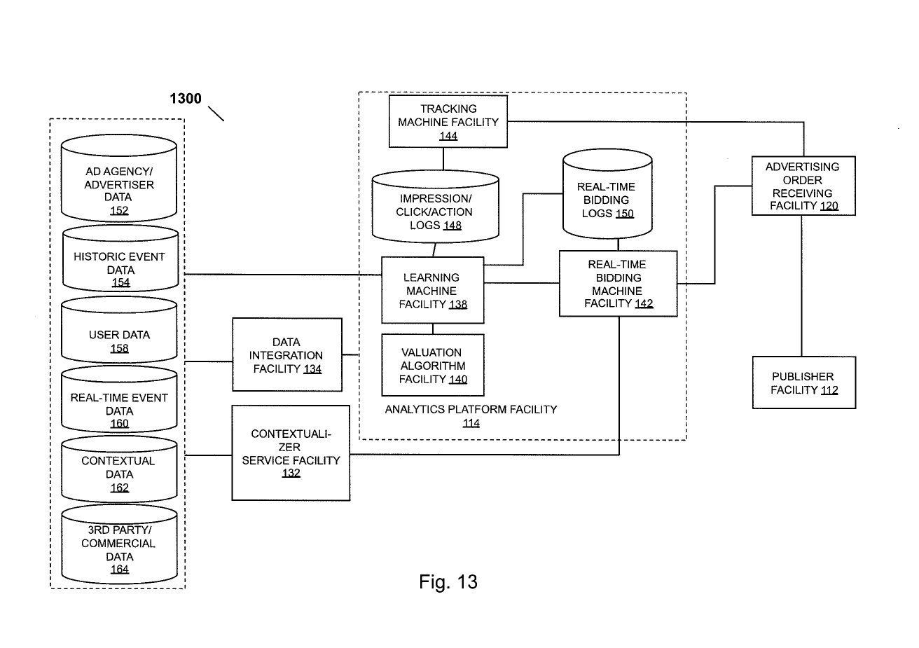

FIG. 13 illustrates a bidding valuation facility 1300 for real-time bidding and valuation for purchases of online advertising placements in accordance with an embodiment of the invention. The bidding valuation facility 1300 may further include (apart from other facilities) a publisher facility 112, an analytics platform facility 114, an advertising order sending and receiving facility 120, a contextualizer service facility 132, a data integration facility 134, one or more databases providing different types of data for use by the analytics facility. In an embodiment of the invention, the analytics platform facility 114 may include a learning machine facility 138, valuation algorithm facility 140, a real-time bidding machine facility 142, a tracking machine facility 144, an Impression/Click/Action Logs facility 148, and a real-time bidding logs facility 150.

In embodiments of the invention, a learning machine 138 may be used to develop targeting algorithms for the real-time bidding machine facility 142. The learning machine 138 may learn patterns, including social behavior and inferred demographics among others, which may be used to target online ads. Further, the learning machine facility 138 may be coupled to one or more databases. In embodiments of the invention, the one or more databases may include an ad agency/advertiser database 152. The ad agency data 152 may include campaign descriptors, and may describe the channels, times, budgets, and other information that may be allowed for diffusion of advertising messages. The ad agency data 152 may also include campaign and historic logs that may be the placement for each advertising message to be shown to the user. The ad agency data 152 may include one or more of the following: an identifier for the user, the channel, time, price paid, ad message shown, and user resulting user actions, or some other type of campaign or historic log data. Further, the advertiser data 152 may include business intelligence data, or some other type of data, which may describe dynamic and/or static marketing objectives. In an example, the amount of overstock of a given product that the advertiser 104 has in its warehouses may be described by the advertiser data 152. Further, the one or more databases may include an historic event database. The historic event data 154 may be used to correlate the time of user events with other events happening in their region. In an example, response rates to certain types of advertisements may be correlated to stock market movements. The historic event data 154 may include, but is not limited to, weather data, events data, local news data, or some other type of data. Further, the one or more databases may include a user database. The user data 158 may include data provided by third parties that may contain personally linked information about advertising recipients. This information may provide users with preferences, or other indicators, which may label or describe the users. Further, the one or more databases may include a real-time event database. The real-time event data 160 may include data similar to historic data, but that is more current. The real-time event data 160 may include, but is not limited to, data that is current to the second, minute, hour, day, or some other measure of time. In an example, if the learning machine facility 138 finds a correlation between advertising performance and historic stock market index values, the real-time stock market index value may be used to value advertisements by the real-time bidding machine facility 142. Further, the one or more databases may include a contextual database that may provide contextual data 162 associated with a publisher 112, publisher's website and the like. The one or more databases may further include a third party/commercial database.

Further, in embodiments of the invention, a data integration facility 134 and the contextualizer service facility 132 may be associated with the analytics platform facility 114 and the one or more databases. The data integration facility 134 may facilitate the integration of different types of data from one or more databases into the analytics platform facility 114. The contextualizer service facility 132 may identify the contextual category of a medium for advertising and/or publisher content, website, or other publisher ad context. In an example, a contextualizer may analyze web content to determine whether a web page contains content about sports, finance, or some other topic. This information may be used as an input to the learning machine facility in order to identify the relevant publishers and/or web pages where ads may appear. In another embodiment, the location of the ad on the publisher 112 web page may be determined based on the information. In an embodiment of the invention, the contextualizer service facility 132 may also be associated with the real-time bidding machine facility 142 and/or with the one or more databases.

In embodiments of the invention, the real-time bidding machine facility 142 may receive a bid request message from the publisher facility 112. A real-time bidding machine facility 142 may be considered a “real-time” facility since it may reply to a bid request that is associated with a time constraint, where the reply occurs substantially simultaneous to the request receipt, and/or very near in time to the request receipt. The real-time bidding machine facility 142 may use a non-stateless method to calculate which advertising message to show, while the user waits for the system to decide. The real-time bidding machine facility 142 may perform the real-time calculation using algorithms provided by the learning machine 138, dynamically estimating an optimal bid value. In embodiments, an alternative real-time bidding machine facility 142 may have a stateless configuration to determine an advertisement to present.

Further, in an embodiment of the invention, the real-time bidding machine facility 142 may dynamically determine an anticipated economic valuation for each of the plurality of potential placements for an advertisement based on receiving the request to place an advertisement for the publisher facility 112. In response to receiving a request to place an advertisement for the publisher facility 112, the real-time bidding machine facility 142 may dynamically determine an anticipated economic valuation for each of the plurality of potential placements for the advertisement, and may select and decide whether to present the available placements based on the economic valuation to the publisher facility 112.

In embodiments, the real-time bidding machine facility 142 may include altering a model for dynamically determining the economic valuation prior to processing a second request for a placement. The alteration of the model may be based at least in part on the machine learning facility. In an embodiment of the invention, prior to selecting and presenting at least one of the plurality of available placements, and/or plurality of advertisements, the behavior of an economic valuation model may be altered to produce a second set of valuations for each of the plurality of placements. In embodiments, the steps for selecting and presenting may be based on the second set of valuations. Further, in an embodiment of the invention, the request for the placement may be a time-limited request. Further, the economic valuation model may evaluate performance information relating to each of the plurality of advertisement placements. The dynamically variable economic valuation model may also be used to determine an anticipated economic valuation. In an embodiment of the invention, the dynamically variable economic valuation model may evaluate bid values in relation to economic valuations for a plurality of placements. Dynamic determination of an anticipated economic valuation for each of the plurality of potential placements for an advertisement may be based at least in part on advertiser data 152, historical event data 154, user data 158, real-time event data 160, contextual data 162, and third-party commercial data 164.

In embodiments, the real-time bidding machine facility 142, in response to receiving a request to place an advertisement for a publisher 112, may dynamically determine an anticipated economic valuation for each of a plurality of potential placements for an advertisement. After the economic valuation model has been determined, the real-time bidding machine facility 142 may determine a bid amount based at least in part on the anticipated economic valuation for each of the plurality of potential placements for the advertisement. The determination of the bid amount may include analysis of real-time bidding logs. In another embodiment, the determination of the bid amount may include analytic modeling based at least in part on machine learning. Analytic modeling based at least in part on machine learning may include the analysis of historical log data summarizing at least one of: ad impressions, ad clickthroughs, and user actions taken in association with an ad presentation. Further, in an embodiment of the invention, the determination of the bid amount may include analysis of data from the contextualizer service facility 132.

In an embodiment of the invention, the real-time bidding machine facility 142, in response to receiving a request to place an advertisement for a publisher 112, may dynamically determine an anticipated economic valuation for each of a plurality of potential placements for the advertisement. After the economic valuation model has been determined, the real-time bidding machine facility 142 may determine a bid amount based at least in part on the anticipated economic valuation for each of the plurality of potential placements for the advertisement. Thereafter, the real-time bidding machine facility may select an optimum placement for the advertisement, from among the plurality of potential placements. Further, the real-time bidding machine facility 142 may automatically place a bid on the optimum placement for the advertisement.

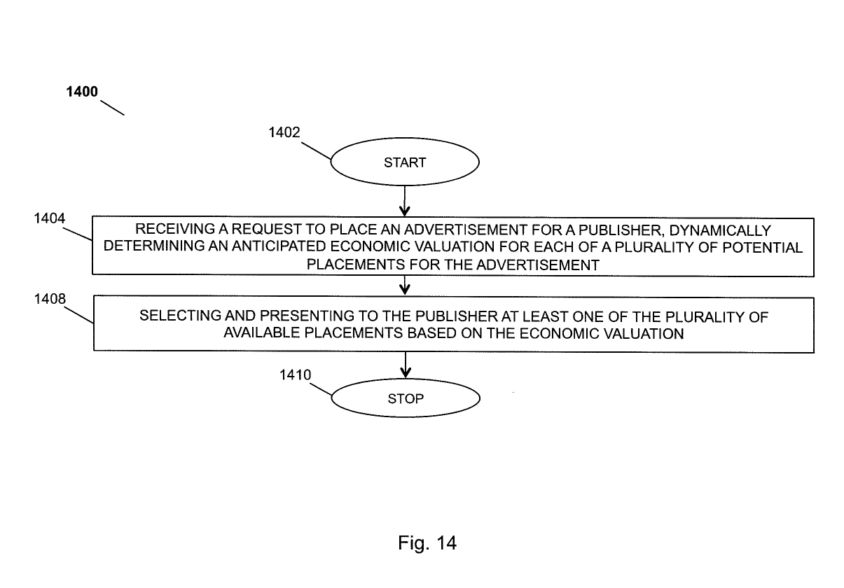

FIG. 14 illustrates a method 1400 for selecting and presenting to a publisher at least one of the plurality of available placements, and/or plurality of advertisements, based on an economic valuation. The method initiates at step 1402. At step 1404, in response to receiving a request to place an advertisement for a publisher, an anticipated economic valuation may be dynamically determined for each of a plurality of potential placements for the advertisement. Thereafter at step 1408, at least one of the plurality of available placements, and/or plurality of advertisements, may be selected and presented to the publisher based at least in part on the economic valuation. In an embodiment of the invention, a model for dynamically determining the economic valuation may be altered prior to processing a second request for a placement. In an embodiment the model may be altered based at least in part on machine learning. In an embodiment of the invention, prior to the steps of selecting and presenting, the behavior of an economic valuation model may be altered to produce a second set of valuations for each of the plurality of placements. In an embodiment, the steps of selecting and presenting steps may be based on the second set of valuations, which are used in place of the first valuation(s). In embodiments, the request for the placement may be a time limited request. In embodiments, the economic valuation model, as described herein, may evaluate performance information relating to each of a plurality of advertisement placements. A dynamically variable economic valuation model may be used to determine the anticipated economic valuation and to evaluate bid values in relation to economic valuations for a plurality of placements. An anticipated economic valuation for each of a plurality of potential placements for an advertisement may be based at least in part on advertiser data, historical event data, user data, real-time event data, contextual data or third-party commercial data. The method terminates at step 1410.

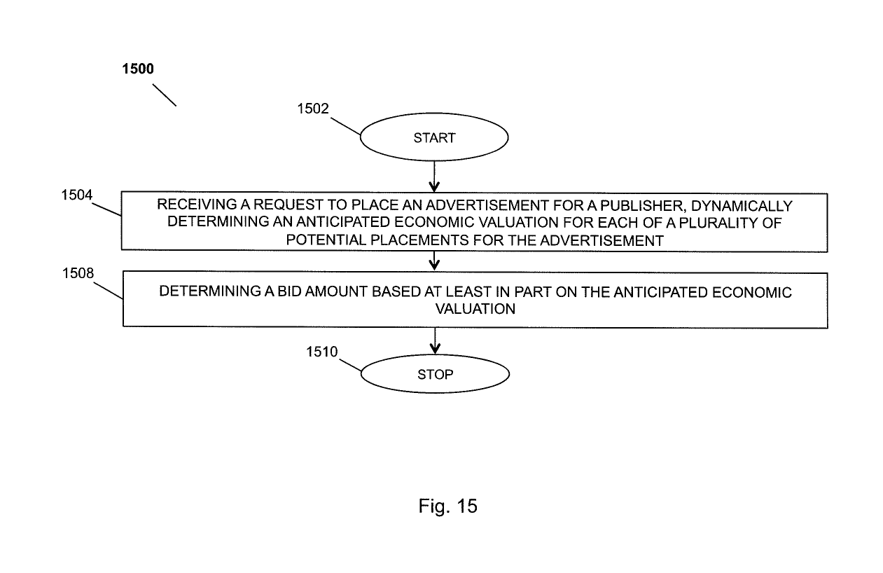

FIG. 15 illustrates a method 1500 for determining a bid amount, in accordance with an embodiment of the invention. The method initiates at step 1502. At step 1504, in response to receiving a request to place an advertisement for a publisher, an anticipated economic valuation for each of a plurality of potential placements for the advertisement may be dynamically determined. Thereafter at step 1508, a bid amount based at least in part on the anticipated economic valuation for each of the plurality of potential placements for the advertisement is determined. In an embodiment of the invention, the determination of the bid amount may include analysis of real-time bidding logs and/or analytic modeling based at least in part on machine learning. In an embodiment of the invention, the analytic modeling may include the analysis of historical log data summarizing at least one of: ad impressions, ad clickthroughs, and user actions taken in association with an ad presentation. In an embodiment of the invention, determination of the bid amount may include analysis of data from a contextualizer service.

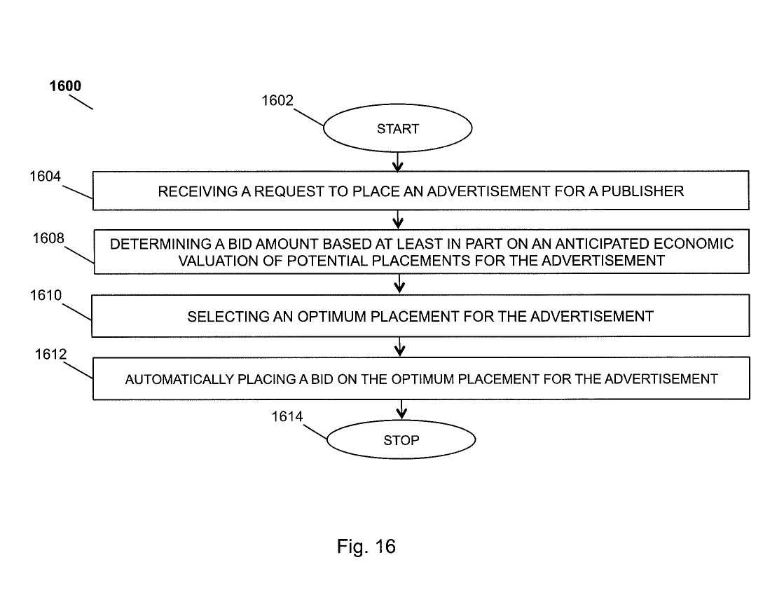

FIG. 16 illustrates a method 1600 for automatically placing a bid on an optimum placement for an advertisement, where the optimum placement is selected based at least in part on an anticipated economic valuation. The method initiates at step 1602. At step 1604, in response to receiving a request to place an advertisement for a publisher, an anticipated economic valuation for each of a plurality of potential placements for the advertisement is dynamically determined. Thereafter at step 1608, a bid amount based at least in part on the anticipated economic valuation for each of the plurality of potential placements for the advertisement is determined. Further at step 1610, an optimum placement for the advertisement is selected, from among the plurality of potential placements, based at least in part on the bid amount. Finally at step 1612, a bid on the optimum placement for the advertisement is automatically placed. The method terminates at step 1614.

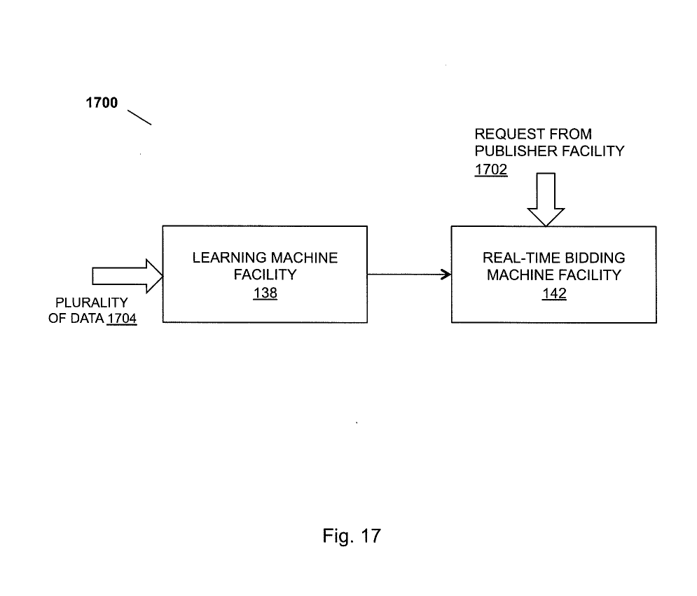

FIG. 17 illustrates a real-time facility 1700 for targeting bids for online advertising purchases in accordance with an embodiment of the invention. The real-time facility may include a learning machine facility 138 and a real-time bidding machine facility 142. In an embodiment of the invention, the real-time bidding machine facility 142 may receive a bid request message from the publisher facility 112. The real-time bidding machine facility 142 may be considered a “real-time” facility since it may reply to a bid request that is associated with a time constraint. The real-time bidding machine facility 142 may perform the real-time calculation using targeting algorithms provided by the learning machine 138, dynamically estimating an optimal bid value.

Further, in an embodiment of the invention, the real-time bidding machine facility 142 may deploy an economic valuation model that may dynamically determine an economic valuation (based on receiving the request to place an advertisement for the publisher facility 112) for each of one or more potential placements for an advertisement. In response to receiving a request to place an advertisement for the publisher facility 112, the real-time bidding machine facility 142 may dynamically determine an economic valuation for each of one or more potential placements for the advertisement. After the economic valuation has been determined, the real-time bidding machine facility 142 may select and present to a user at least one of the plurality of available placements, and/or plurality of advertisements, based on the economic valuation. In an embodiment, the selection and presentation to the publisher 112 may include a recommended bid amount for the at least one of the plurality of available placements, and/or plurality of advertisements. The bid amount may be associated with a time constraint. Further, in an embodiment, the refinement through machine learning may include comparing economic valuation models by retrospectively comparing the extent to which the models reflect actual economic performance of advertisements. In embodiments of the invention, the economic valuation model may be based at least in part on advertising agency data 152, real-time event data 160, historic event data 154, user data 158, third party commercial data 164, and contextual data 162. In an embodiment, the advertising agency data 152 may include at least one campaign descriptor. In embodiments, the campaign descriptor may be historic log data, advertising agency campaign budget data, and a datum indicating a temporal restraint on an advertising placement.

In embodiments, the learning machine facility 138 may receive an economic valuation model. The economic valuation model may be based at least in part on analysis of real-time bidding log data 150 from the real time bidding machine facility 142. Thereafter, the learning machine facility 138 may refine the economic valuation model. The refinement may be based at least in part on analysis of an advertising impression log. In an embodiment of the invention, the refinement of the economic valuation model may include a data integration step during which data to be used in the learning machine facility 138 may be transformed into a data format that may be read by the learning machine facility 138. The format may be a neutral format. Further in embodiments, the refinement of the economic valuation model using the learning machine may be based at least in part on a machine learning algorithm. The machine learning algorithms may be based at least in part on naïve bayes analytic techniques and on logistic regression analytic techniques. Further, the real-time bidding machine facility 142 may use the refined economic valuation model to classify each of a plurality of available advertising placements. The classification may be a datum indicating a probability of each of the available advertising placements achieving an advertising impression. The real-time bidding machine facility 142 may then prioritize the available advertising placements based at least in part on the datum indicating the probability of achieving an advertising impression. Thereafter, the real-time bidding machine facility 142 may select and present to a user at least one of the plurality of available placements, and/or plurality of advertisements, based on the prioritization.

In an embodiment of the invention, an economic valuation model deployed by the real-time bidding machine facility 142 may be refined by the machine learning facility to evaluate information relating to one or more available placements to predict an economic valuation for each of the one or more placements. Further, in embodiments, the learning machine facility 138 may obtain different types of data to refine the economic valuation model. The different types of data may include, without any limitation, agency data 152 which may include campaign descriptors, and may describe the channels, times, budgets, and other information that may be allowed for diffusion of advertising messages. The agency data 152 may also include campaign and historic logs that may be the placement for each advertising message to be shown to the user. The agency data 152 may also include one or more of the following: an identifier for the user, the channel, time, price paid, ad message shown, and user resulting user actions, or some other type of campaign or historic log data. Further, the different types of data may include business intelligence data, or some other type of data, which may describe dynamic and/or static marketing objectives.

In embodiments of the invention, the learning machine facility 138 may perform an auditing and/or supervisory function, including, but not limited to, optimizing the methods and systems as described herein. In other embodiments of the information, the learning system 138 may learn from multiple data sources, and base optimization of the methods and systems as described herein at least in part on the multiple data sources. In embodiments, the methods and systems as described herein may be used in Internet-based applications, mobile applications, fixed-line applications (e.g., cable media), or some other type of digital application. In embodiments, the methods and systems as described herein may be used in one or more addressable advertising media, including, but not limited to, set top boxes, digital billboards, radio ads, or some other type of addressable advertising media.

Further, in embodiments of the invention, the learning machine facility 138 may utilize various types of algorithms to refine the economic valuation models of the real-time bidding machine facility 142. The algorithms may include, without any limitations, decision tree learning, association rule learning, artificial neural networks, genetic programming, inductive logic programming, support vector machines, clustering, Bayesian networks, and reinforcement learning. In an embodiment of the invention, the various types of algorithms may produce classifiers, which are algorithms that may classify whether or not an advertisement is likely to produce an action. In their basic form, they may return a “yes” or “no” answer and/or a score indicating the strength of certainty of the classifier. When calibration techniques are applied, they may return a probability estimate of the likelihood of a prediction to be correct.

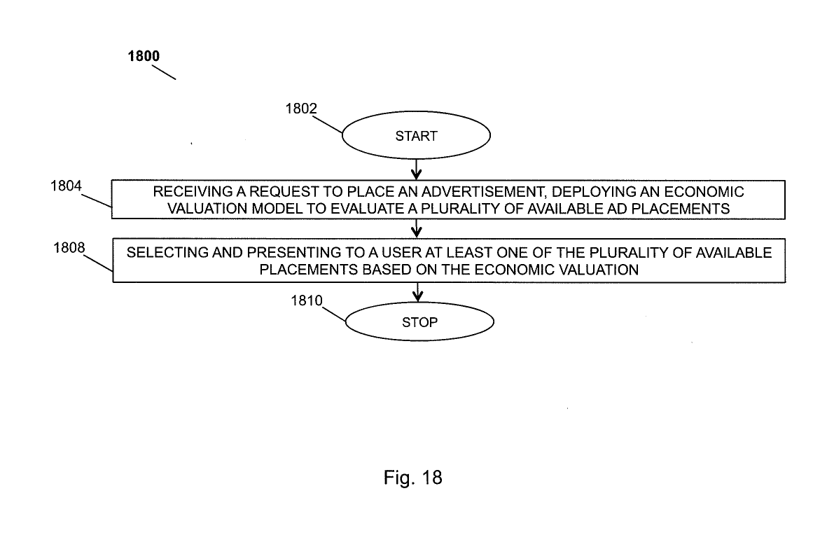

FIG. 18 illustrates a method 1800 for selecting and presenting to a user at least one of a plurality of available advertising placements based on an economic valuation. The method initiates at step 1802. At step 1804, an economic valuation model may be deployed, in response to receiving a request to place an advertisement for a publisher. The economic valuation model may be refined through machine learning to evaluate information relating to a plurality of available placements, and/or plurality of advertisements, to predict an economic valuation for each of the plurality of placements. In an embodiment, the refinement through machine learning may include comparing economic valuation models by retrospectively comparing the extent to which the models reflect actual economic performance of advertisements. Further, the economic valuation model may be based at least in part on advertising agency data, real time event data, historic event data, user data, third-party commercial data and contextual data. Furthermore, the advertising agency data may include at least one campaign descriptor. Moreover, the campaign descriptor may be historic log data, is advertising agency campaign budget data and advertising agency campaign budget data. At step 1808, at least one of the plurality of available placements, and/or plurality of advertisements, based on the economic valuation may be selected and presented to a user. In an embodiment, the selection and presentation to the publisher may include a recommended bid amount for the at least one of the plurality of available placements, and/or plurality of advertisements. Further, the bid amount may be associated with a time constraint. The method 1800 terminates at step 1810.

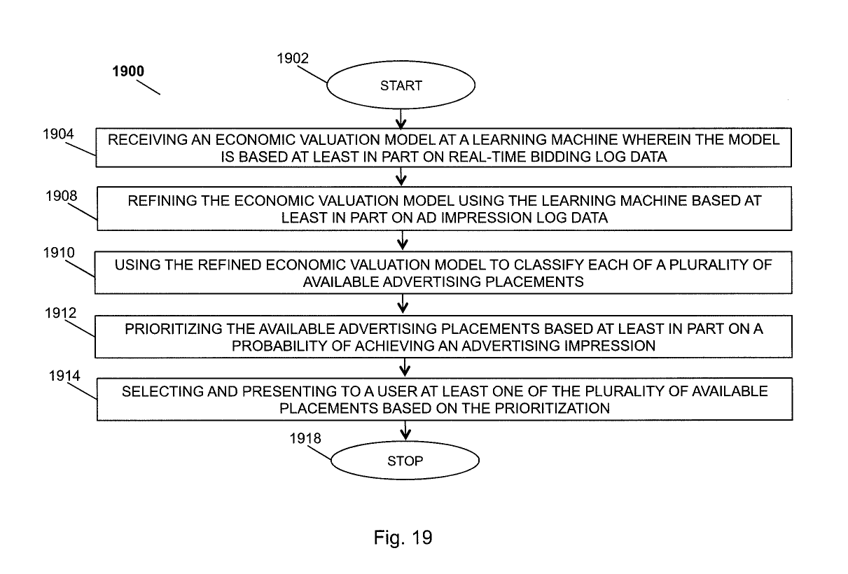

FIG. 19 illustrates a method 1900 for selecting from a plurality of available advertising placements a prioritized placement opportunity based at least in part on an economic valuation model using real-time bidding log data. The method 1900 initiates at step 1902. At step 1904, an economic valuation model at a learning machine may be received. The economic valuation model may be based at least in part on analysis of a real-time bidding log from a real time bidding machine. At step 1908, the economic valuation model may be refined using the learning machine. In an embodiment, the refinement may be based at least in part on analysis of an advertising impression log. Further, the refinement of the economic valuation model may include a data integration step during which data to be used in the learning machine may be transformed into a data format that can be read by the learning machine. In an embodiment, the format may be a neural format. Furthermore, the refinement of the economic valuation model using the learning machine may be based at least in part on a machine learning algorithm. The machine learning algorithm may be based at least in part on naïve bayes analytic techniques. Moreover, the machine learning algorithm may be based at least in part on logistic regression analytic techniques. At step 1910, the refined economic valuation model may be used to classify each of a plurality of available advertising placements. Each classification may be a summarized using a datum indicating a probability of each of the available advertising placements achieving an advertising impression. Further, at step 1912, the available advertising placements may be prioritized based at least in part on the datum. In addition, at step 1914, at least one of the plurality of available placements, and/or plurality of advertisements, may be selected and presented to a user based on the prioritization. The method 1900 terminates at step 1918.

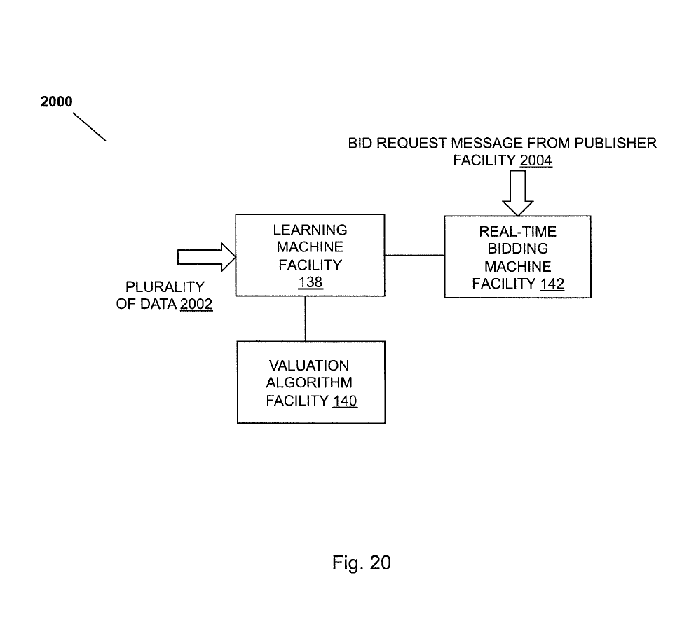

FIG. 20 illustrates a real-time facility 2000 for selecting alternative algorithms for predicting purchase price trends for bids for online advertising, in accordance with an embodiment of the invention. The real-time facility 1700 may include a learning machine facility 138, a valuation algorithm facility 140, a real-time bidding machine facility 142, a plurality of data 2002, and a bid request message 2004 from a publisher facility 112. In an embodiment of the invention, the real-time bidding machine facility 142 may receive a bid request message 1704 from the publisher facility 112. The real-time bidding machine facility 142 may be considered a “real-time” facility since it may reply to a bid request that is associated with time constraint. The real-time bidding machine facility 142 may perform a real-time calculation using targeting algorithms provided by the learning machine facility 138 to predict purchase price trends for bids for online advertising. In an embodiment of the invention, the learning machine facility 138 may select an alternative algorithm based on the performance of a currently operating algorithm for predicting purchase price trends for bids for online advertising. In another embodiment of the invention, the learning machine facility 138 may select an alternative algorithm based on the predicted performance of the alternative algorithm for predicting purchase price trends for bids for online advertising. Further, in an embodiment of the invention, learning machine facility 138 may obtain the alternative algorithms from the valuation algorithm facility 140.

In embodiments, the real-time bidding machine facility 142 may apply a plurality of algorithms to predict performance of online advertising placements. Once the plurality of algorithms is applied, the real-time bidding machine facility 142 may track the performance of the plurality of algorithms under a variety of market conditions. The real-time bidding machine facility 142 may then determine the performance conditions for a type of algorithm from the plurality of algorithms. Thereafter, the real-time bidding machine facility 142 may track the market conditions and may select the algorithm for predicting performance of advertising placements based on the current market conditions.

In embodiments, at least one of the plurality of algorithms to predict performance may include advertiser data 152. The advertiser data 152 my include business intelligence data, or some other type of data, which may describe dynamic and/or static marketing objectives. In another embodiment of the invention, at least one of the plurality of algorithms to predict performance may include historic event data 154. The historic event data 154 may be used to correlate the time of user events with the occurrence of other events in their region. In an example, response rates to certain types of advertisements may be correlated to stock market movements. The historic event data 154 may include, but is not limited to, weather data, events data, local news data, or some other type of data. In yet another embodiment of the invention, at least one of the plurality of algorithms to predict performance may include user data 158. The user data 158 may include data provided by third parties, which may contain personally linked information about advertising recipients. This information may provide users with preferences, or other indicators, which may label or describe the users. In yet another embodiment of the invention, at least one of the plurality of algorithms to predict performance may include real-time event data 160. The real-time event data 160 may include data similar to historic data, but more current. The real-time event data 160 may include, but is not limited to, data that is current to the second, minute, hour, day, or some other measure of time. In yet another embodiment of the invention, at least one of the plurality of algorithms to predict performance may include contextual data 162. In yet another embodiment of the invention, at least one of the plurality of algorithms to predict performance may include third party commercial data.

Further, in an embodiment of the invention, the real-time bidding machine facility 142 may use a primary model for predicting an economic valuation of each of a plurality of available web publishable advertisement placements based in part on past performance and prices of similar advertisement placements. The real-time bidding machine facility 142 may also use a second model for predicting an economic valuation of each of the plurality of web publishable advertisement placements. After predicting the economic valuations using both the primary model and the second model, the real-time bidding machine facility 142 may compare the valuations produced by the primary model and the second model to determine a preference between the primary model and the second model. In an embodiment of the invention, the comparison of the valuations may include retrospectively comparing the extent to which the models reflect actual economic performance of advertisements. Further, in an embodiment of the invention, the primary model may be an active model responding to purchase requests. The purchase request may be a time limited purchase request. In an embodiment of the invention, the second model may replace the primary model as the active model responding to purchase requests. Further, the replacement may be based on a prediction that the second model may perform better than the primary model under the current market conditions. In embodiments of the invention, the prediction may be based at least in parts on machine learning, historical advertising performance data 130, historical event data, and real-time event data 160.

In another embodiment of the invention, the real-time bidding machine facility 142 may use a primary model for predicting an economic valuation of each of a plurality of available mobile device advertisement placements based in part on past performance and prices of similar advertisement placements. The real-time bidding machine facility 142 may also use a second model for predicting an economic valuation of each of the plurality of mobile device advertisement placements. After predicting the economic valuations using both the primary model and the second model, the real-time bidding machine facility 142 may compare the valuations produced by the primary model and the second model to determine a preference between the primary model and the second model. In an embodiment of the invention, the comparison of the valuations may include retrospectively comparing the extent to which the models reflect actual economic performance of advertisements. Further, in an embodiment of the invention, the primary model may be an active model responding to purchase requests. The purchase request may be a time limited purchase request. In an embodiment of the invention, the second model may replace the primary model as the active model responding to purchase requests. Further, the replacement may be based on a prediction that the second model may perform better than the primary model under the current market conditions.

In an embodiment of the invention, the economic valuation model deployed by the real-time bidding machine facility 142 may be refined by the machine learning facility 138 to evaluate information relating to one or more available placements to predict an economic valuation for each of the one or more placements.

In embodiments, the learning machine facility 138 may obtain different types of data to refine the economic valuation model. The different types of data may include, without any limitation, advertiser data 152, historic event data 154, user data 158, real-time event data 160, contextual data 162, and third party commercial data. The different types of data may have different formats and information that may not directly relate to the advertisements, such as market demographics data, and the like. In embodiments of the invention, the different types of data in different formats may be translated into a neutral format or specific to a format compatible with the learning machine facility 138, or some other data type suitable for the learning machine facility 138.

In embodiments, the learning machine facility 138 may utilize various types of algorithms to refine the economic valuation model of the real-time bidding machine facility 142. The algorithms may include, without any limitations, decision tree learning, association rule learning, artificial neural networks, genetic programming, inductive logic programming, support vector machines, clustering, Bayesian networks, and reinforcement learning.

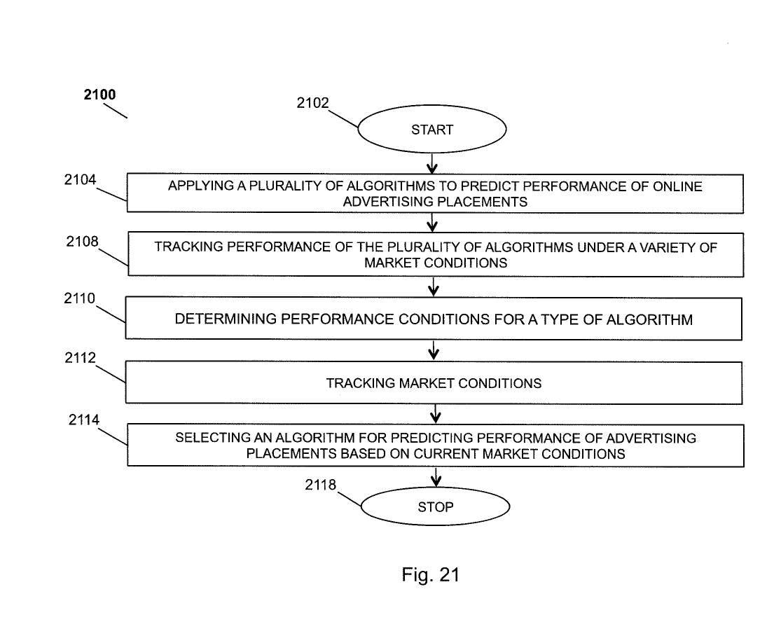

FIG. 21 illustrates a method 2100 of the present invention for predicting performance of advertising placements based on current market conditions. The method initiates at step 2102. At step 2104, a plurality of algorithms to predict performance of online advertising placement may be applied. In embodiments of the invention, at least one of the plurality of algorithms to predict performance may include advertiser data, historic event data, user data, real-time event data, contextual data, and third-party commercial data, of some other type of data. Thereafter, at step 2108, the performance of the plurality of algorithms may be tracked under various market conditions. Further, at step 2110, the performance for a type of algorithm may be determined and then the market conditions may be tracked at step 2112. Finally, at step 2114, an algorithm for predicting performance of advertising placements based on the current market conditions may be selected. The method terminates at step 2118.

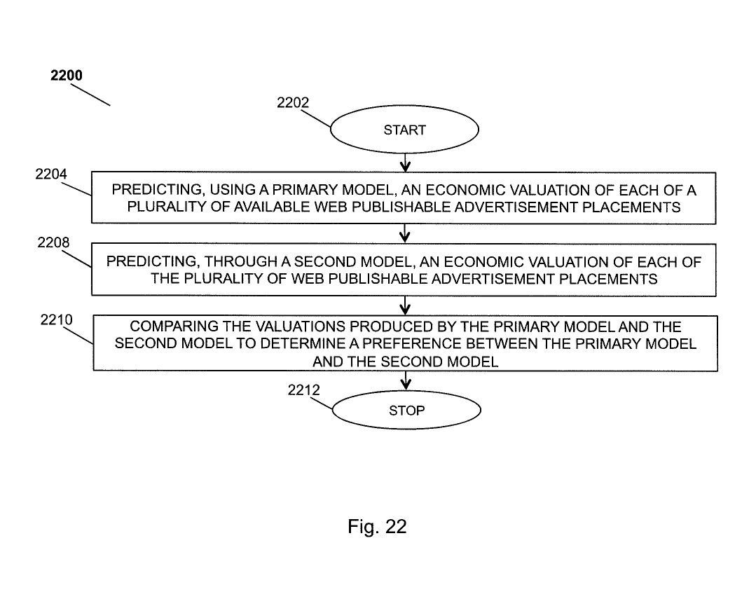

FIG. 22 illustrates a method 2200 for determining a preference between a primary model and a second model for predicting an economic valuation, in accordance with an embodiment of the invention. The method initiates at step 2202. At step 2204, using a primary model, an economic valuation of each of a plurality of available web publishable advertisement placements may be predicted. The economic valuation may be based in part on past performance and prices of similar advertisement placements. At step 2208, using a second model, an economic valuation of each of the plurality of available web publishable advertisement placements may be predicted. Thereafter, at step 2210, the economic valuations using both the primary model and the second model may be compared to determine a preference between the primary model and the second model. In an embodiment of the invention, the comparison of the valuations may include retrospectively comparing the extent to which the models reflect actual economic performance of advertisements. Further, in an embodiment of the invention, the primary model may be an active model responding to purchase requests. The purchase request may be a time limited purchase request. In an embodiment of the invention, the second model may replace the primary model as the active model responding to purchase requests. Further, the replacement may be based on a prediction that the second model may perform better than the primary model under the current market conditions. In embodiments of the invention, the prediction may be based at least in parts on machine learning, historical advertising performance data, historical event data, and real-time event data. The method terminates at step 2212.

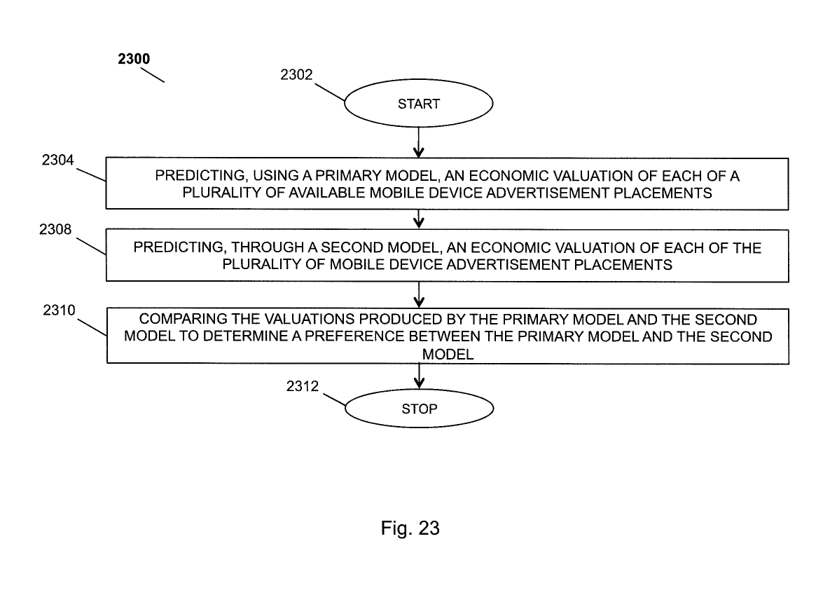

Referring now to FIG. 23, which illustrates a method 2300 for determining a preference between a primary model and a second model for predicting economic valuation, in accordance with another embodiment of the invention. The method initiates at step 2302. At step 2304, using a primary model, an economic valuation of each of a plurality of available mobile device advertisement placements may be predicted. The economic valuation may be based in part on past performance and prices of similar advertisement placements. At step 2308, using a second model an economic valuation of each of the plurality of available mobile device advertisement placements may be predicted. Thereafter, at step 2310, the economic valuations using both the primary model and the second model may be compared to determine a preference between the primary model and the second model. In an embodiment of the invention, the comparison of the valuations may include retrospectively comparing the extent to which the models reflect actual economic performance of advertisements. Further, in an embodiment of the invention, the primary model may be an active model responding to purchase requests. The purchase request may be a time limited purchase request. In an embodiment of the invention, the second model may replace the primary model as the active model responding to purchase requests. Further, the replacement may be based on a prediction that the second model may perform better than the primary model under the current market conditions. The method terminates at step 2312.

Further in an embodiment of the invention, the real-time bidding machine facility 142 may receive a request to place an advertisement from a publisher facility 112. In response to this request, the real-time bidding machine facility 142 may deploy a plurality of competing economic valuation models to predict an economic valuation for each of a plurality of available advertisement placements. After deploying the plurality of economic valuation models, the real-time bidding machine facility 142 may evaluate each valuation produced by each of the plurality of competing economic valuation models to select one economic valuation model as a current valuation of an advertising placement.

In an embodiment of the invention, the economic valuation model may be based at least in part on real-time event data 160. The real-time event data 160 may include data similar to historic data, but more current. The real-time event data 160 may include, but is not limited to, data that is current to the second, minute, hour, day, or some other measure of time. In another embodiment of the invention, the economic valuation model may be based at least in part on historic event data 154. The historic event data 154 may be used to correlate the time of user events with the occurrence of other events in their region. In an example, response rates to certain types of advertisements may be correlated to stock market movements. The historic event data 154 may include, but is not limited to, weather data, events data, local news data, or some other type of data. In yet another embodiment of the invention, the economic valuation model may be based at least in part on the user data 158. The user data 158 may include data provided by third parties, which may contain personally linked information about advertising recipients. This information may provide users with preferences, or other indicators, which may label or describe the users. In yet another embodiment of the invention, the economic valuation model may be based at least in part on the third party commercial data. In an embodiment of the invention, the third party commercial data may include financial data relating to historical advertisement impressions. In yet another embodiment of the invention, the economic valuation model may be based at least in part on contextual data 162. In yet another embodiment of the invention, the economic valuation model may be based at least in part on advertiser data 152. The advertiser data 152 may include business intelligence data, or some other type of data, which may describe dynamic and/or static marketing objectives. In yet another embodiment of the invention, the economic valuation model may be based at least in part on ad agency data 152. The ad agency data 152 may also include campaign and historic logs that may be the placement for each advertising message to be shown to the user. The ad agency data 152 may also include one or more of the following: an identifier for the user, the channel, time, price paid, ad message shown, and user resulting user actions, or some other type of campaign or historic log data. In yet another embodiment of the invention, the economic valuation model may be based at least in part on the historical advertising performance data 130. In yet another embodiment of the invention, the economic valuation model may be based at least in part on the machine learning.

In an embodiment of the invention, an economic valuation model deployed by the real-time bidding machine facility 142 may be refined by the machine learning facility 138 to evaluate information relating to one or more available placements to predict an economic valuation for each of the one or more placements.

In an embodiment of the present invention, after the real-time bidding machine facility 142 receives a request to place an advertisement from a publisher facility 112, the real-time bidding machine facility 142 in response to this request may deploy a plurality of competing economic valuation models to predict an economic valuation for each of the plurality of advertisement placements. After deploying the plurality of economic valuation models, the real-time bidding machine facility 142 may evaluate each valuation produced by each of the plurality of competing economic valuation models to select one as a first valuation of an advertising placement. Upon selecting the first valuation, the real-time bidding machine facility 142 may reevaluate each valuation produced by each of the plurality of competing economic valuation models to select one as a revised valuation of an advertising placement. In an embodiment of the invention, the revised valuation may be based at least in part on analysis of an economic valuation model using real-time event data 160 that was not available at the time of selecting the first valuation. Thereafter, real-time bidding machine facility 142 may replace the first valuation by the second revised valuation for use in deriving a recommended bid amount for the advertising placement. In an embodiment of the invention, the request may be received from a publisher 112 and the recommended bid amount may be automatically sent to the publisher 112. In another embodiment of the invention, the request may be received from a publisher 112 and a bid equaling the recommended bid amount may be automatically placed on behalf of the publisher 112. In an embodiment of the invention, the recommended bid amount may be associated with a recommended time of ad placement. In another embodiment of the invention, the recommended bid amount may be further derived by analysis of a real-time bidding log that may be associated with a real-time bidding machine facility 142. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

In another embodiment of the invention, after the real-time bidding machine facility 142 receives a request to place an advertisement from a publisher facility 112, the real-time bidding machine facility 142 may deploy a plurality of competing economic valuation models to evaluate information relating to a plurality of available advertisement placements. The real-time bidding machine facility 142 may deploy the competing economic valuation models to predict an economic valuation for each of the plurality of advertisement placements. After deploying the plurality of economic valuation models, the real-time bidding machine facility 142 may evaluate each valuation produced by each of the plurality of competing economic valuation models to select one valuation as a future valuation of an advertising placement. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

In another embodiment of the invention, after the real-time bidding machine facility 142 receives a request to place an advertisement from a publisher facility 112 the real-time bidding machine facility 142 may deploy a plurality of competing economic valuation models to evaluate information relating to a plurality of available advertisement placements. The real-time bidding machine facility 142 may deploy the competing economic valuation models to predict an economic valuation for each of the plurality of advertisement placements. After deploying the plurality of economic valuation models, the real-time bidding machine facility 142 may evaluate in real time, each valuation produced by each of the plurality of competing economic valuation models to select one valuation as a future valuation of an advertising placement. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention. In an embodiment of the invention, the future valuation may be based at least in part on simulation data describing a future event. In an embodiment of the invention, the future event may be a stock market fluctuation. Further, in an embodiment of the invention, the simulation data describing future event may be derived from analysis of historical event data.

In an embodiment of the invention, after the real-time bidding machine facility 142 receives a request to place an advertisement from a publisher facility 112, the real-time bidding machine facility 142 may deploy a plurality of competing real-time bidding algorithms relating to a plurality of available advertisement placements to bid for advertisement placements. After deploying the plurality of competing real-time bidding algorithms, the real-time bidding machine facility 142 may evaluate each bidding algorithm to select a preferred algorithm. In an embodiment of the invention, the competing real-time bidding algorithms may use data from a real-time bidding log. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

In another embodiment of the invention, after the real-time bidding machine facility 142 receives a request to place an advertisement from a publisher facility 112, the real-time bidding machine facility 142 may deploy a plurality of competing real-time bidding algorithms relating to a plurality of available advertisement placements. The real-time bidding machine facility 142 may deploy the plurality of competing real-time bidding algorithms to bid for advertisement placements. After deploying the plurality of competing real-time bidding algorithms, the real-time bidding machine facility 142 may evaluate each bid recommendation created by the competing real-time bidding algorithms. The real-time bidding machine facility 142 may reevaluate each bid recommendation created by the competing real-time bidding algorithms to select one as a revised bid recommendation. In an embodiment of the invention, the revised bid recommendation may be based at least in part on a real-time bidding algorithm using real-time event data 160 that was not available at the time of selecting the bid recommendation. Thereafter, the real-time bidding machine facility 142 may replace the bid recommendation with the revised bid recommendation for use in deriving a recommended bid amount for the advertising placement. In an embodiment of the invention, the replacement may occur in real-time relative to the receipt of the request to place an advertisement.

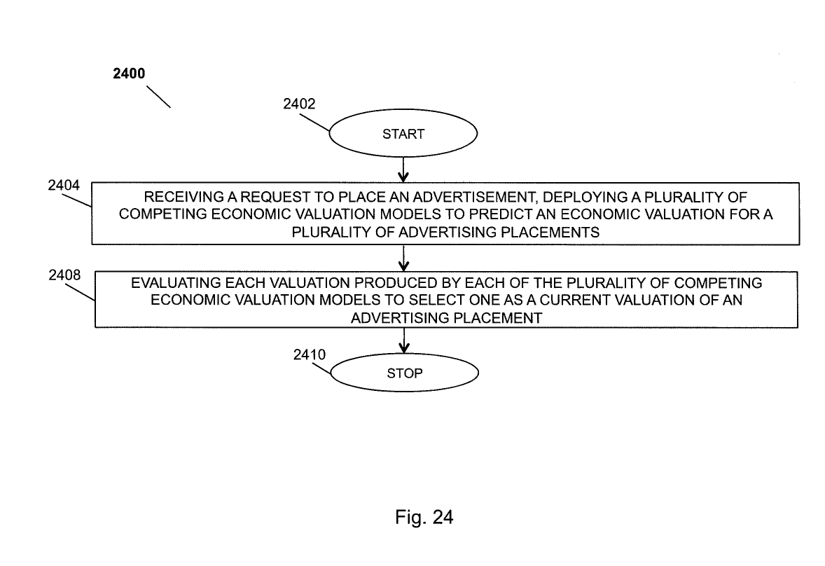

Referring now to FIG. 24 which illustrates a method 2400 for selecting one among multiple competing valuation models in real-time bidding for advertising placements, in accordance with an embodiment of the invention. The method initiates at step 2402. At step 2404, in response to receiving a request to place an advertisement, a plurality of competing economic valuation models may be deployed to predict an economic valuation for each of the plurality of advertisement placements. Thereafter at step 2408, each valuation produced by each of the plurality of competing economic valuation models may be evaluated to select one of the valuation models as a current valuation of an advertising placement. In embodiments of the invention, the economic valuation model may be based at least in part on real-time event data, historic event data, user data, contextual data, advertiser data, ad agency data, historical advertising performance data, machine learning and third-party commercial data. In an embodiment of the invention, the third party commercial data may include financial data relating to historical advertisement impressions. The method terminates at step 2410. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

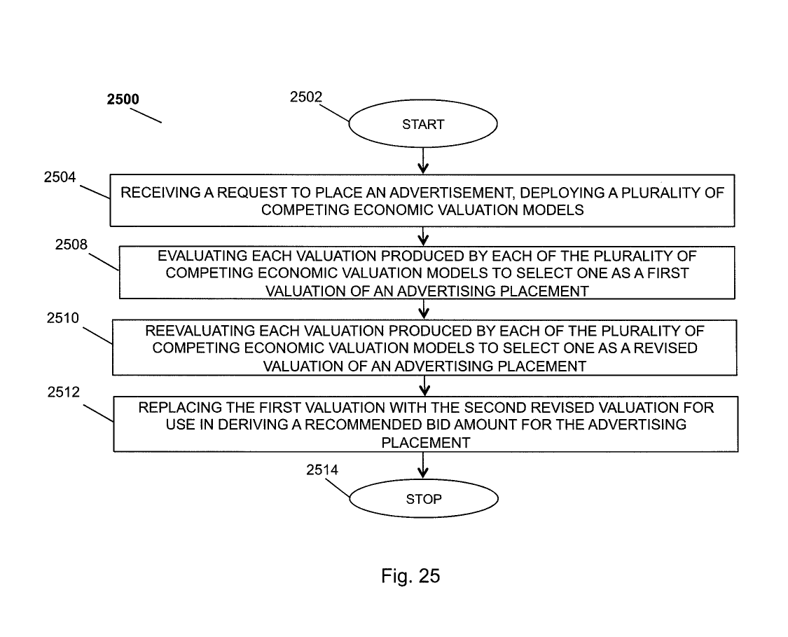

FIG. 25 illustrates a method 2500 for replacing a first economic valuation model by a second economic valuation model for deriving a recommended bid amount for an advertising placement. The method initiates at step 2502. At step 2504, in response to receiving a request to place an advertisement, a plurality of competing economic valuation models may be deployed to predict an economic valuation for each of the plurality of advertisement placements. Thereafter at step 2508, valuations produced by each of the plurality of competing economic valuation models may be evaluated and a first valuation of an advertising placement may be then selected. Further at step 2510, each valuation produced by each of the plurality of competing economic valuation models may be reevaluated. One of the competing economic valuation models may then be selected as a revised valuation of an advertising placement. The revised valuation may be based at least in part on analysis of an economic valuation model using real-time event data that was not available at the time of selecting the first valuation. Further at step 2512, the first valuation may be replaced with the second revised valuation for use in deriving a recommended bid amount for the advertising placement. In an embodiment of the invention, the request may be received from a publisher and the recommended bid amount may be automatically sent to the publisher. In another embodiment of the invention, the request may be received from a publisher and a bid equaling the recommended bid amount may be automatically placed on behalf of the publisher. In yet another embodiment of the invention, recommended bid amount may be associated with a recommended time of ad placement. Still in another embodiment of the invention, recommended bid amount may be further derived by analysis of a real-time bidding log that is associated with a real-time bidding machine. The method terminates at step 2514. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

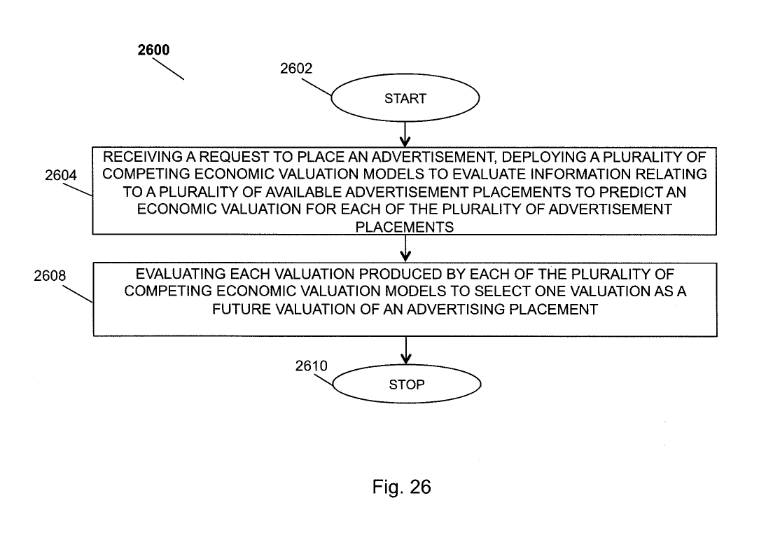

FIG. 26 illustrates a method 2600 for evaluating multiple economic valuation models and selecting one valuation as a future valuation of an advertising placement, in accordance with an embodiment of the invention. The method initiates at step 2602. At step 2604, in response to receiving a request to place an advertisement, a plurality of competing economic valuation models may be deployed. Information relating to a plurality of available advertisement placements may be evaluated to predict an economic valuation for each of the plurality of advertisement placements. Further at step 2608, each valuation produced by each of the plurality of competing economic valuation models may be evaluated to select one valuation as a future valuation of an advertising placement. The method terminates at step 2610. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

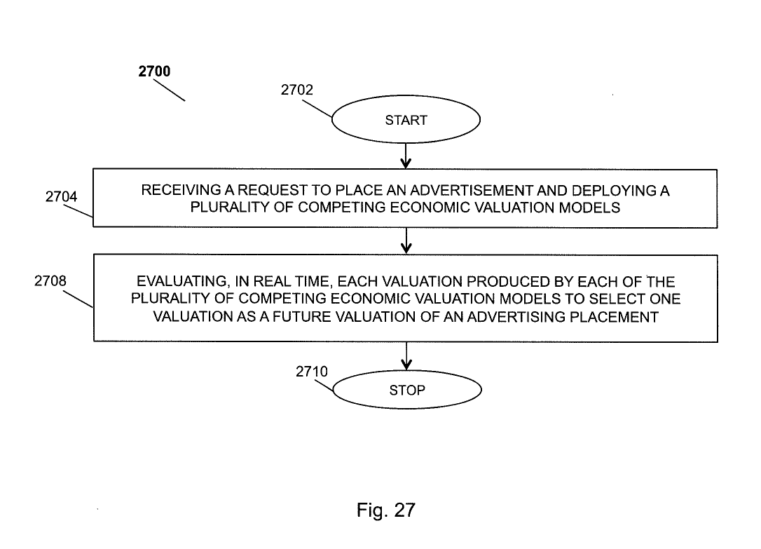

FIG. 27 illustrates a method 2700 for evaluating in real time multiple economic valuation models and selecting one valuation as a future valuation of an advertising placement, in accordance with an embodiment of the invention. The method initiates at step 2702. At step 2704, in response to receiving a request to place an advertisement, a plurality of competing economic valuation models may be deployed. Information relating to a plurality of available advertisement placements may be evaluated to predict an economic valuation for each of the plurality of advertisement placements. Thereafter at step 2708, each valuation produced by each of the plurality of competing economic valuation models may be evaluated in real-time to select one valuation as a future valuation of an advertising placement. In an embodiment of the invention, the future valuation may be based at least in part on simulation data describing a future event. In another embodiment of the invention, the future event may be a stock market fluctuation. In an embodiment of the invention, the simulation data describing future event may be derived from analysis of historical event data that may be chosen based at least in part on contextual data relating to an advertisement to be placed in the advertising placement. The method terminates at step 2710. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

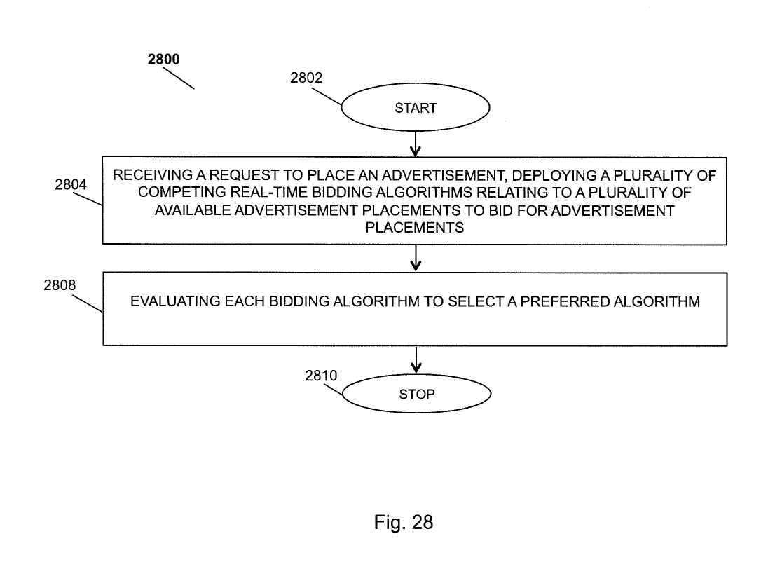

FIG. 28 illustrates a method 2800 for evaluating multiple bidding algorithms to select a preferred algorithm for placing an advertisement, in accordance with an embodiment of the invention. The method initiates at step 2802. At step 2804, in response to receiving a request to place an advertisement, a plurality of competing real-time bidding algorithms may be deployed. The bidding algorithms may be related to a plurality of available advertisement placements to bid for advertisement placements.

Thereafter at step 2808, each bidding algorithm may be evaluated to select a preferred algorithm. The method terminates at step 2810. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

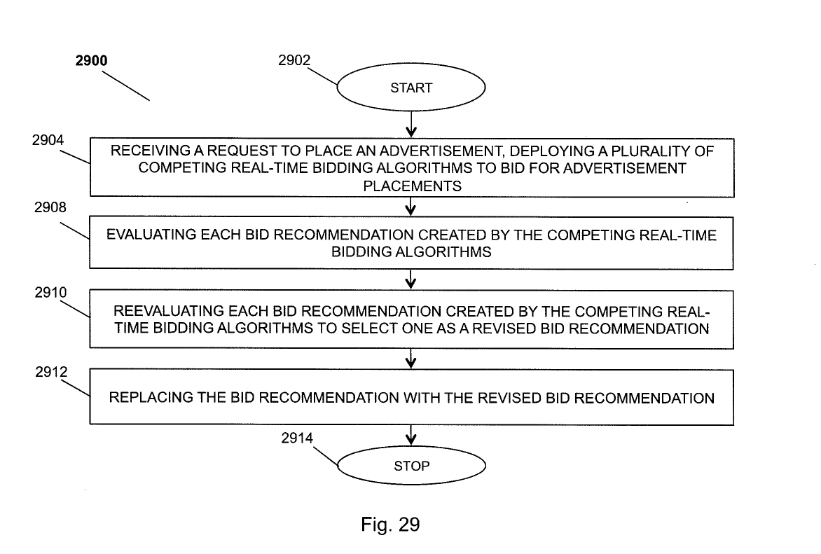

FIG. 29 illustrates a method 2900 for replacing a bid recommendation with a revised bid recommendation for an advertising placement, in accordance with an embodiment of the invention. The method initiates at step 2902. At step 2904, in response to receiving a request to place an advertisement, a plurality of competing real-time bidding algorithms relating to a plurality of available advertisement placements to bid for advertisement placements may be deployed. At step 2908, each bid recommendation created by the competing real-time bidding algorithms may be evaluated. Further at step 2910, each bid recommendation created by the competing real-time bidding algorithms may be revaluated to select one as a revised bid recommendation. In an embodiment, the revised bid recommendation is based at least in part on a real-time bidding algorithm using real-time event data that was not available at the time of selecting the bid recommendation. Thereafter at step 2912, the bid recommendation may be replaced with the revised bid recommendation for use in deriving a recommended bid amount for the advertising placement. In an embodiment of the invention, the replacement may occur in real-time relative to the receipt of the request to place an advertisement. The method terminates at step 2914. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

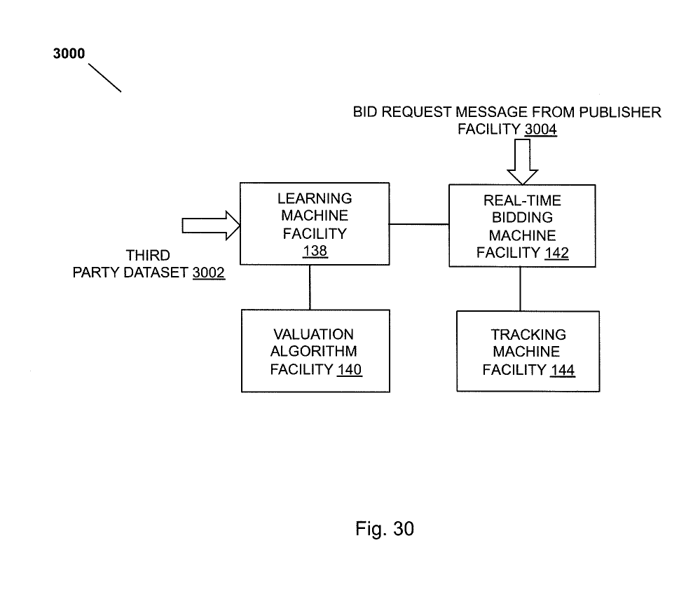

FIG. 30 illustrates a real-time facility 3000 for measuring the value of additional third party data 164, in accordance with an embodiment of the invention. The real-time facility 2700 may include a learning machine facility 138, a valuation algorithm facility 140, a real-time bidding machine facility 142, additional third party dataset 3002, a bid request message 3004 from a publisher facility 112, and a tracking facility 144. In an embodiment of the invention, the real-time bidding machine facility 142 may receive a bid request message 3004 from the publisher facility 112. The real-time bidding machine facility 142 may be considered a “real-time” facility since it may reply to a bid request that is associated with time constraint. The real-time bidding machine facility 142 may perform the real-time calculation using targeting algorithms provided by the learning machine facility 138. In an embodiment of the invention, the real-time bidding machine facility 142 may deploy an economic valuation model to perform the real-time calculation.

In embodiments, the learning machine facility 138 may obtain a third party data set 3002 to refine an economic valuation model. In an embodiment of the invention, the third party dataset 2702 may include data relating to users of advertising content. In embodiment of the invention, the data relating to users of advertising content may include demographic data, transaction data, conversion data, or some other type of data. In another embodiment of the invention, the third party dataset may include contextual data 162 relating to the plurality of available placements, and/or plurality of advertisements. In embodiments of the invention, the contextual data 162 may be derived from a contextualizer service 132 that may be associated with the learning machine facility 138. In yet another embodiment of the invention, the third party dataset 3010 may include financial data relating to historical advertisement impressions. Further, in embodiments of the invention, the economic valuation model may based at least in part on real-time event data, historic event data 154, user data 158, third-party commercial data, advertiser data 152, and advertising agency data 152.

In an embodiment of the invention, the real-time bidding machine facility 142 may receive an advertising campaign dataset and may split the advertising campaign dataset into a first advertising campaign dataset and a second advertising campaign dataset. Thereafter, the real-time bidding machine facility 142 may deploy an economic valuation model that may be refined through machine learning to evaluate information relating to a plurality of available placements, and/or plurality of advertisements, to predict an economic valuation for placement of ad content from the first advertising campaign dataset. In an embodiment of the invention, the machine learning may be based at least in part on a third party dataset. The machine learning may be achieved by the learning machine facility 138. After the refinement of the evaluation model, the real-time bidding machine facility 142 may place ad content from the first and second advertising campaign datasets within the plurality of available placements, and/or plurality of advertisements. Content from the first advertising campaign may be placed based at least in part on the predicted economic valuation, and content from the second advertising campaign dataset may be placed based on a method that does not rely on the third party dataset. The real-time bidding machine facility 142 may further receive impression data from a tracking machine facility 144 that may relate to the ad content placed from the first and second advertising campaign datasets. In an embodiment of the invention, the impression data may include data regarding user interactions with the ad content. Thereafter, the real-time bidding machine facility 142, may determine a value of the third party dataset based at least in part on a comparison of impression data relating to the ad content placed from the first and second advertising campaign datasets.

Further, in an embodiment of the invention, the real-time bidding machine facility 142 may compute a valuation of the third party dataset 3002 based at least in part on a comparison of advertising impression data relating to ad content placed from first and second advertising campaign datasets. In an embodiment of the invention, the placement of the ad content from the first advertising campaign dataset may be based at least in part on a machine learning algorithm employing the third party dataset 2710 to select optimum ad placements. Thereafter, the real-time bidding machine facility 142 may bill an advertiser 104 a portion of the valuation to place an ad content from the first advertising campaign dataset. In an embodiment of the invention, the computation of the valuation and the billing of the advertiser 104 may be automatically performed upon receipt of a request to place content from the advertiser 104. In another embodiment of the invention, the computation of the valuation may be the result of the comparison of the performance of multiple competing valuation algorithms 140. In an embodiment of the invention, the comparison of the performance of multiple competing valuation algorithms 140 may include the use of valuation algorithms 140 based at least in part on historical data. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

Further in an embodiment of the invention, the real-time bidding machine facility 142 may compute a valuation of a third party dataset 3010 based at least in part on a comparison of advertising impression data relating to ad content placed from first and second advertising campaign datasets. In an embodiment of the invention, the placement of the ad content from the first advertising campaign dataset may be based at least in part on a machine learning algorithm employing the third party dataset 3010 to select optimum ad placements. Thereafter, the real-time bidding machine facility 142 may calibrate a bid amount recommendation for a publisher 112 to pay for a placement of an ad content based at least in part on the valuation. In an embodiment of the invention, the calibration may be adjusted iteratively to account for real-time event data 160 and its effect on the valuation.

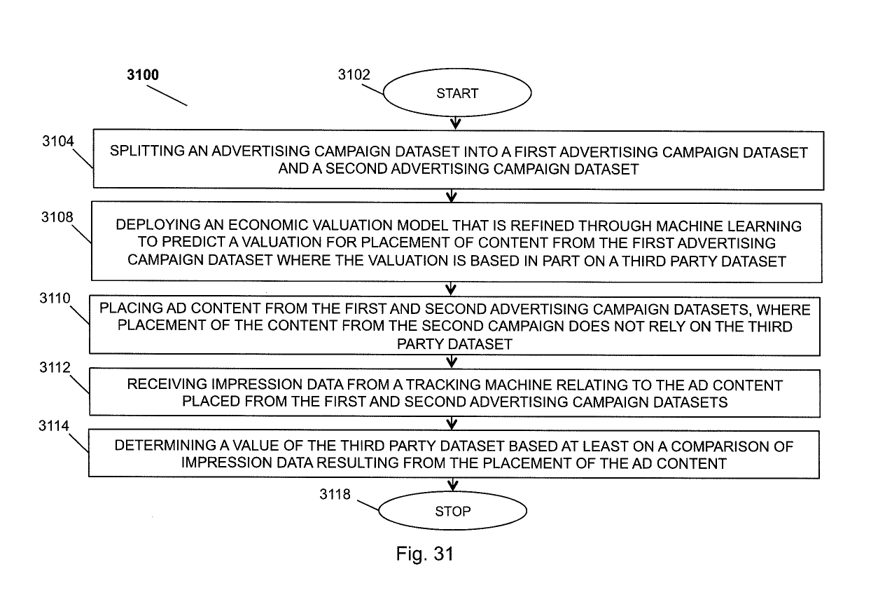

FIG. 31 illustrates a method 3100 for advertising valuation that has the ability to measure the value of additional third party data in accordance with an embodiment of the invention. The method initiates at step 3102. At step 3104, an advertising campaign dataset may be split into a first advertising campaign dataset and a second advertising campaign dataset. At step 3108, an economic valuation model that may be refined through machine learning, may be deployed to evaluate information relating to a plurality of available placements, and/or plurality of advertisements to predict an economic valuation for placement of ad content from the first advertising campaign dataset. In an embodiment of the invention, the machine learning may be based at least in part on a third party dataset. At step 3110, ad content from the first and second advertising campaign datasets may be placed within the plurality of available placements, and/or plurality of advertisements. In an embodiment of the invention, content from the first advertising campaign may be placed based at least in part on the predicted economic valuation, and content from the second advertising campaign dataset may be placed based on a method that does not rely on the third party dataset. Further at step 3112, impression data from a tracking machine facility relating to the ad content placed from the first and second advertising campaign datasets may be received. In an embodiment, the impression data may include data regarding user interactions with the ad content. Thereafter, at step 3114, a value of the third party dataset based at least in part on a comparison of impression data relating to the ad content placed from the first and second advertising campaign datasets may be determined. In an embodiment of the invention, the third party dataset may include data relating to users of advertising content, contextual data relating to the plurality of available placements, and/or plurality of advertisements, or financial data relating to historical advertisement impressions. In an embodiment of the invention, data relating to users of advertising content may include demographic data, transaction data or advertisement conversion data. In an embodiment of the invention, contextual data may be derived from a contextualizer service that is associated with the machine learning facility. In an embodiment of the invention, economic valuation model may be based at least in part on real-time event data, part on historic event data, part on user data, part on third-party commercial data, part on advertiser data or part on advertising agency data. The method terminates at step 3118.

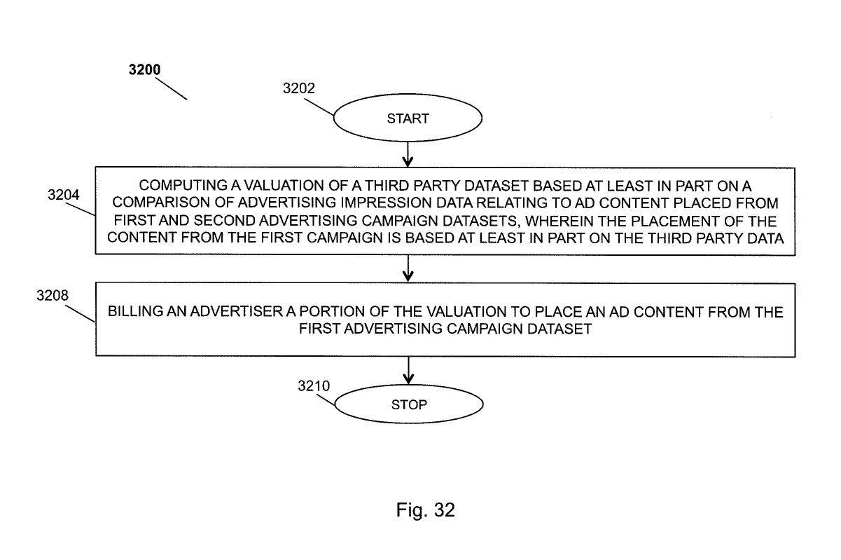

FIG. 32 illustrates a method 3200 for computing a valuation of a third party dataset and billing an advertiser a portion of the valuation, in accordance with an embodiment of the invention. The method initiates at step 3202. At step 3204, a valuation of a third party dataset may be computed based at least in part on a comparison of advertising impression data relating to ad content placed from first and second advertising campaign datasets. In an embodiment of the invention, the placement of the ad content from the first advertising campaign dataset may be based at least in part on a machine learning algorithm employing the third party dataset to select optimum ad placements. Thereafter, at step 3208, an advertiser may be billed a portion of the valuation to place an ad content from the first advertising campaign dataset. In an embodiment of the invention, the computation of the valuation and the billing of the advertiser may be automatically performed upon receipt of a request to place content from the advertiser. In another embodiment of the invention, computation of the valuation may be the result of comparing the performance of multiple competing valuation algorithms. In an embodiment of the invention, comparison of the performance of multiple competing valuation algorithms may include the use of valuation algorithms based at least in part on historical data. The method terminates at step 3210. It will be understood that general analytic methods, statistical techniques, and tools for evaluating competing algorithms and models, such as valuation models, as well as analytic methods, statistical techniques, and tools known to a person of ordinary skill in the art are intended to be encompassed by the present invention and may be used to evaluate competing algorithms and valuation models in accordance with the methods and systems of the present invention.

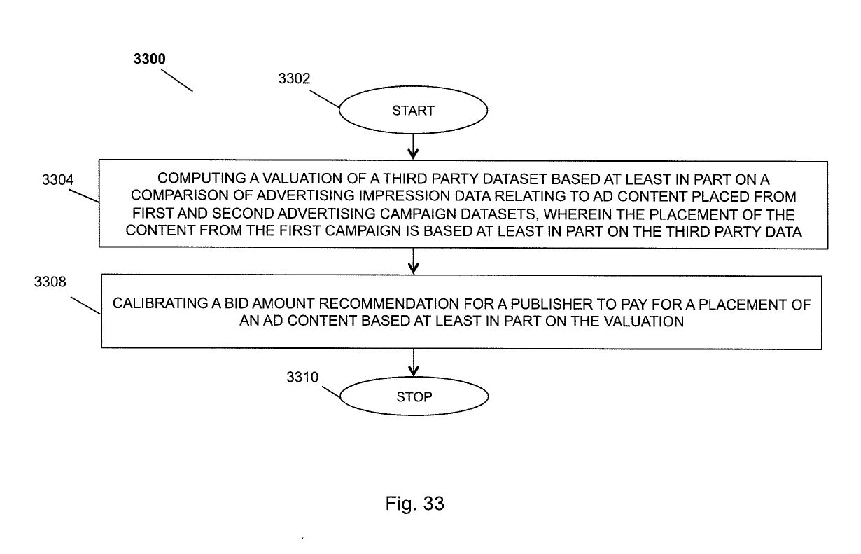

FIG. 33 illustrates a method 3300 for computing a valuation of a third party dataset and calibrating a bid amount recommendation for a publisher to pay for a placement of an ad content based at least in part on the valuation, in accordance with an embodiment of the invention. The method initiates at step 3302. At step 3304, a valuation of a third party dataset may be computed based at least in part on a comparison of advertising impression data relating to ad content placed from first and second advertising campaign datasets. In an embodiment of the invention, the placement of the ad content from the first advertising campaign dataset may be based at least in part on a machine learning algorithm employing the third party dataset to select optimum ad placements. Thereafter, at step 3308, a bid amount recommendation for a publisher to pay may be calibrated for a placement of an ad content based at least in part on the valuation. In an embodiment of the invention, calibration may be adjusted iteratively to account for real-time event data and its effect on the valuation. The method terminates at step 3310.

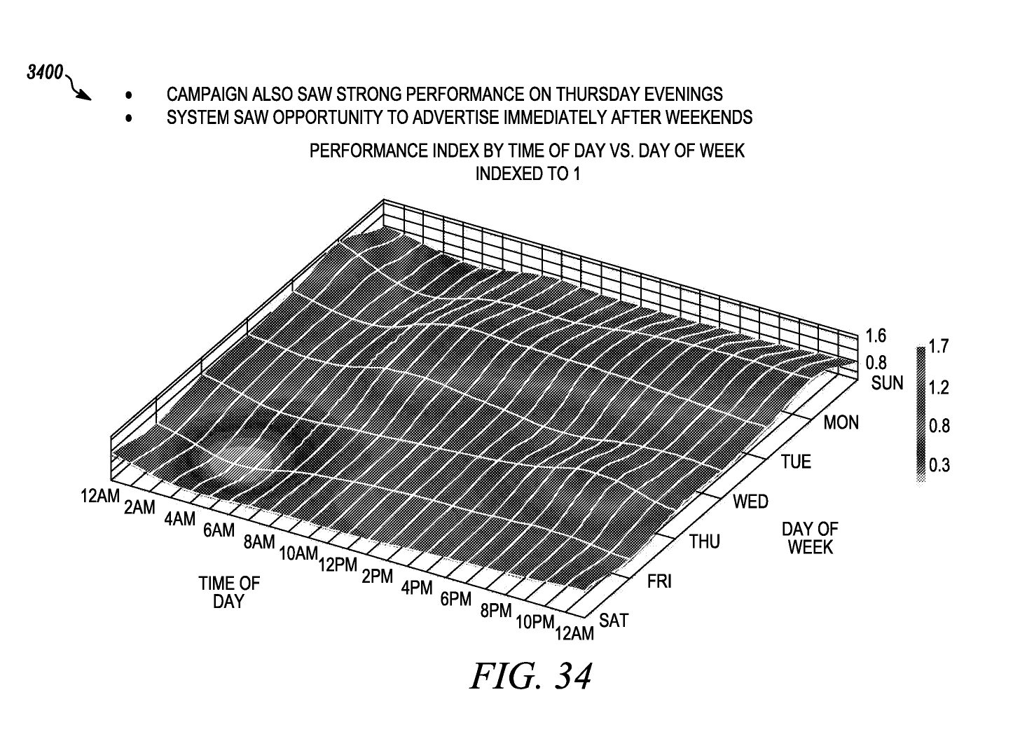

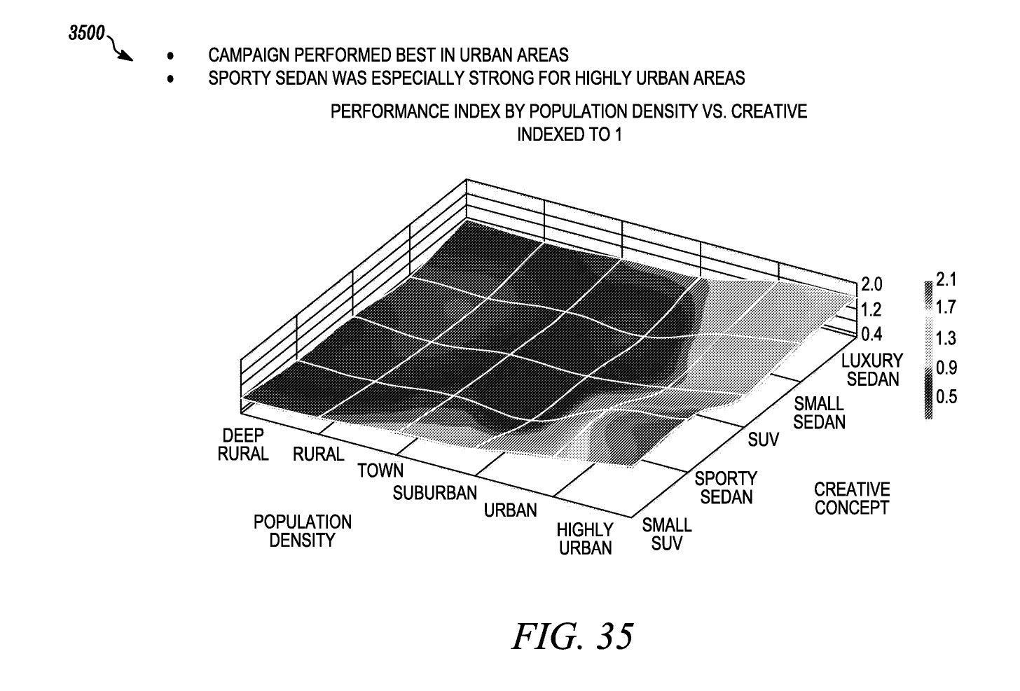

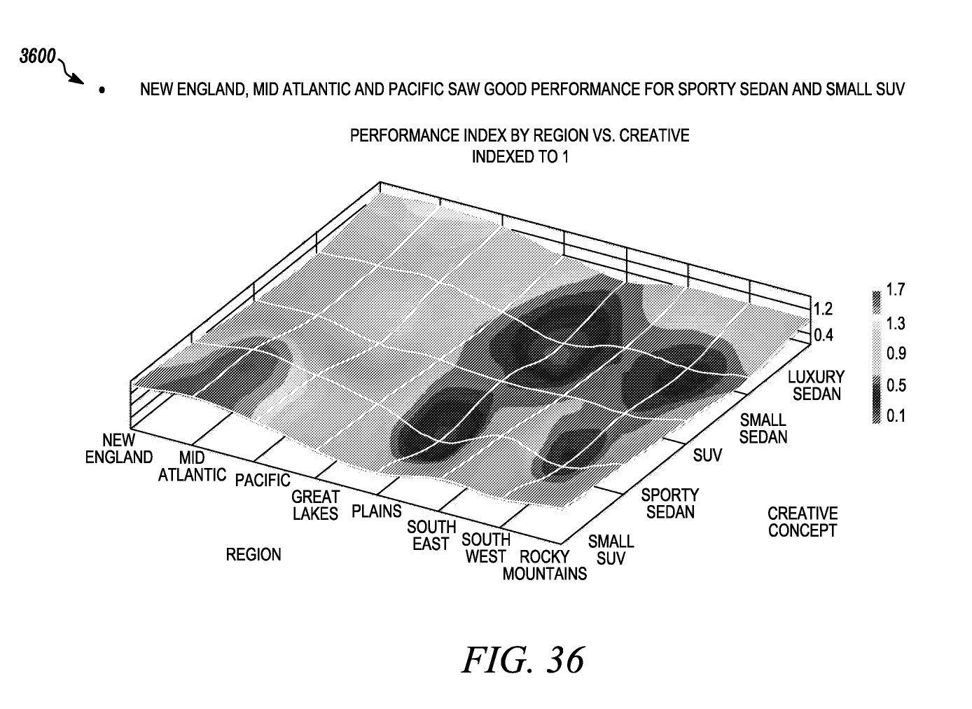

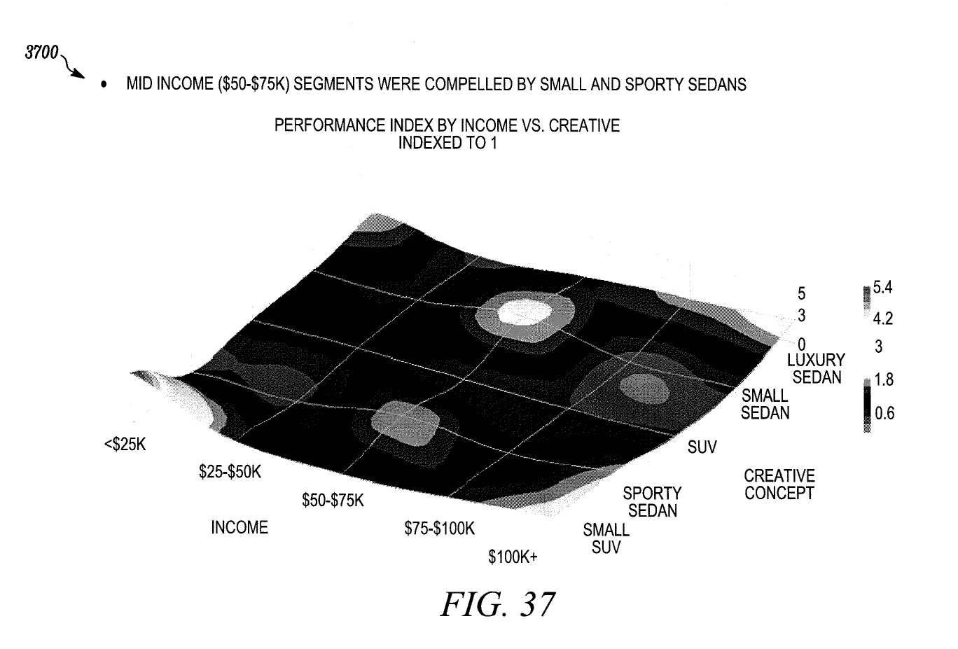

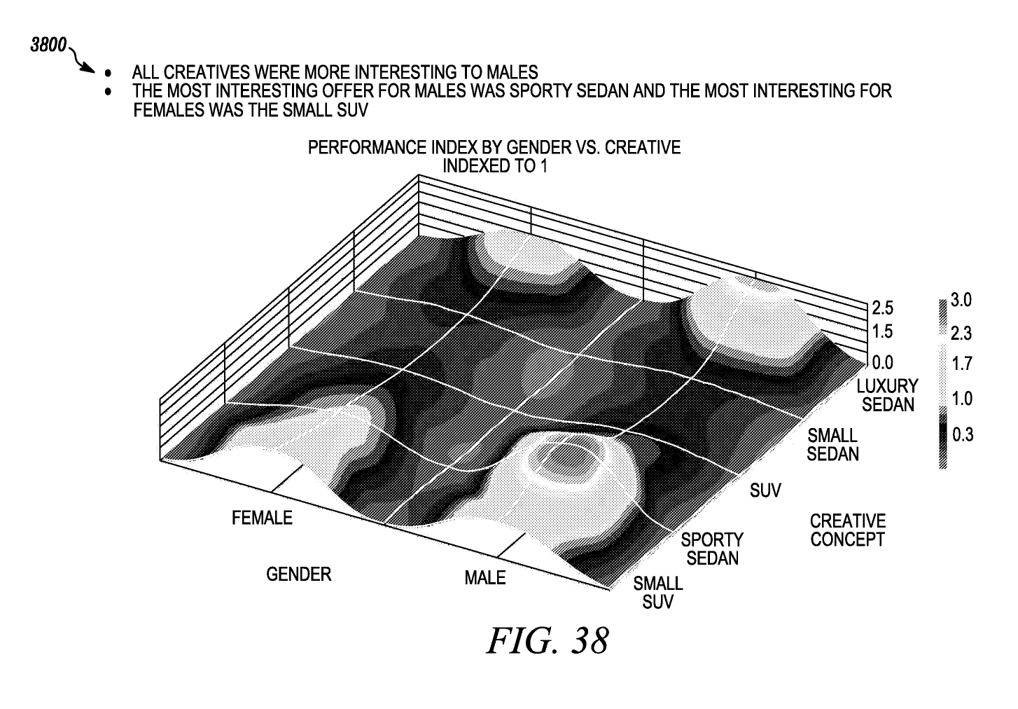

In embodiments, the analytic output of the analytic platform 114 may be illustrated using data visualization techniques including, but not limited to the surface charts shown in FIGS. 34-38. Surface charts may illustrate places of efficiency within, for example, the performance of an advertising campaign, where the height of the surface measures a conversion value per ad impression which is indexed to average performance. In an embodiment, surface areas with a value greater than one (1) may indicate better average conversion value and areas below one (1) may indicate underperformance. A confidence test may be applied to account for lower volume cross-sections of a surface chart and its associated data. FIG. 34 depicts a data visualization embodiment presenting a summary of advertising performance by time of day versus day of the week. FIG. 35 depicts a data visualization embodiment presenting a summary of advertising performance by population density. FIG. 36 depicts a data visualization embodiment presenting a summary of advertising performance by geographic region in the United States. FIG. 37 depicts a data visualization embodiment presenting a summary of advertising performance by personal income. FIG. 38 depicts a data visualization embodiment presenting a summary of advertising performance by gender.

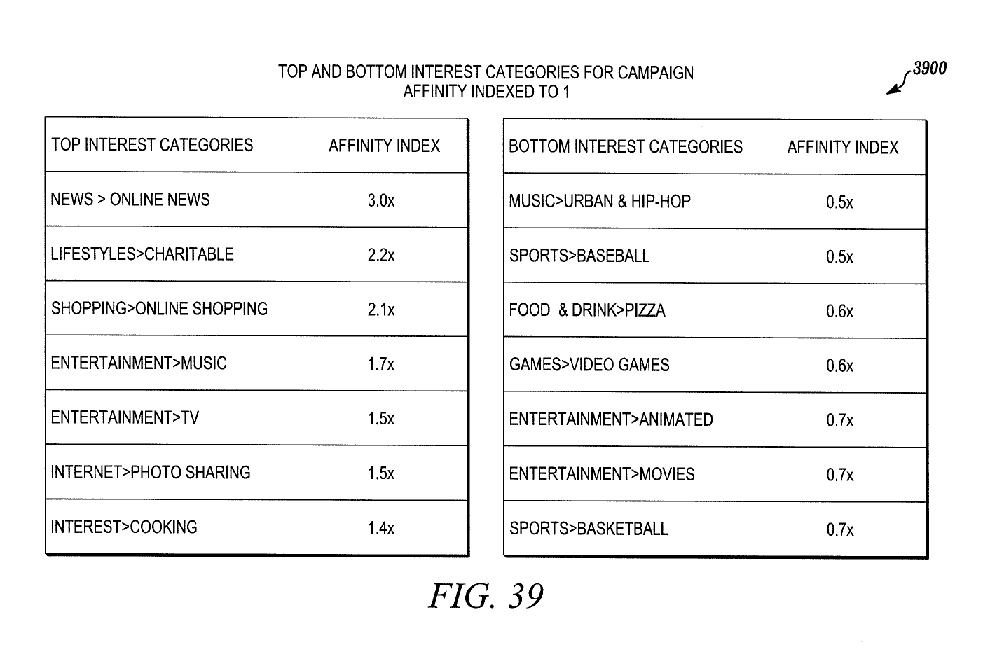

FIG. 39 illustrates an affinity index, by category, for an advertising campaign/brand. The methods and system of the present invention may identify characteristics of consumers that are more likely than the general population to be interested in an advertiser brand. The methods and systems may also identify characteristics of consumers that are less likely than the general population to be interested in the advertiser brand. On the left side of the chart in FIG. 39, the characteristics of consumers that are more interested are presented. The chart also shows an index that represents how much more likely than the general population those consumers are to be engaged with the advertiser brand. The right side of the chart presents the characteristics of consumers that are less interested, and shows an index that represents how much less likely than the general population those consumers are to be engaged with the brand. Indexes, such as that presented in FIG. 39 may take into account the size of the sample, and use a formulation that incorporates sample size and uncertainty ranges.

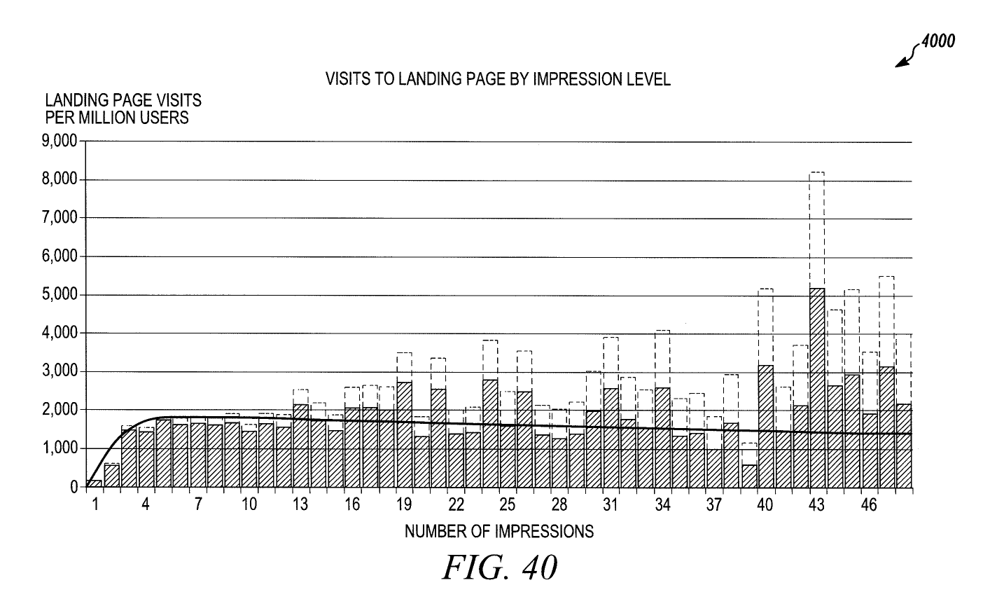

FIG. 40 depicts a data visualization embodiment presenting a summary of page visits by the number of impressions. The methods and system of the present invention may identify the conversion rates that different cohorts of consumers present. As shown in FIG. 40, each cohort may be defined by the number of ads shown to consumer-members of the cohort. The analytic platform 114 may analyze the consumers who saw a given number of ads and compute a conversion rate. The analytic platform 114 may take into account only impressions that were shown to consumers prior to the consumer executing the action. As an example, a consumer who has seen 3 ads before performing an action desirable to the advertiser is member of cohort 3. The other 10members of cohort 3 might have seen 3 ads, but might have not perform any action deemed beneficial to the advertiser. The conversion rate for cohort 3 is 3/10 =0.3 or 300,000 per million consumers. The analysis takes into account the size of the sample, and uses a formulation that incorporates sample size and uncertainty ranges. The analysis also fits a curve that most likely represents the behavior observed across all cohorts.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed:

1. A computer implemented method, the method comprising the steps of:
applying a plurality of algorithms to predict performance of online advertising placements;
tracking performance of the plurality of algorithms under a variety of market conditions;
determining performance conditions for a type of algorithm;
tracking market conditions; and
selecting an algorithm for predicting performance of advertising placements based on current market conditions.

2. The computer implemented method of claim 1, wherein at least one of the plurality of algorithms to predict performance includes advertiser data.

3. The computer implemented method of claim 1, wherein at least one of the plurality of algorithms to predict performance includes historic event data.

4. The computer implemented method of claim 1, wherein at least one of the plurality of algorithms to predict performance includes user data.

5. The computer implemented method of claim 1, wherein at least one of the plurality of algorithms to predict performance includes real-time event data.

6. The computer implemented method of claim 1, wherein at least one of the plurality of algorithms to predict performance includes contextual data.

7. The computer implemented method of claim 1, wherein at least one of the plurality of algorithms to predict performance includes third-party commercial data.

8. A computer program product embodied in a computer readable medium that, when executing on one or more computers, performs the steps of:
predicting, using a primary model, an economic valuation of each of a plurality of available web publishable advertisement placements based in part on past performance and prices of similar advertisement placements;
predicting, through a second model, an economic valuation of each of the plurality of web publishable advertisement placements; and
comparing the valuations produced by the primary model and the second model to determine a preference between the primary model and the second model.

9. The computer program product of claim 8, wherein the primary and second models are used as active models responding to purchase requests.

10. The computer program product of claim 8, wherein the purchase requested is a time limited purchase request.

11. The computer program product of claim 8, wherein the second model replaces the primary model as the active model responding to purchase requests.

12. The computer program product of claim 8, wherein the replacement is based on a prediction that the second model will perform better than the primary model under the current market conditions.

13. The computer program product of claim 12, wherein the prediction is based at least in part on machine learning.

14. The computer program product of claim 12, wherein the prediction is based at least in part on historical advertising performance data.

15. The computer program product of claim 12, wherein the prediction is based at least in part on historical event data.

16. The computer program product of claim 12, wherein the prediction is based at least in part on real-time event data.

17. The computer program product of claim 8, wherein comparing the valuations includes retrospectively comparing the extent to which the models reflect actual economic performance of advertisements.

18. A computer program product embodied in a computer readable medium that, when executing on one or more computers, performs the steps of:
predicting, using a primary model, an economic valuation of each of a plurality of available mobile device advertisement placements based in part on past performance and prices of similar advertisement placements;
predicting, through a second model, an economic valuation of each of the plurality of mobile device advertisement placements; and
comparing the valuations produced by the primary model and the second model to determine a preference between the primary model and the second model.

19. The computer program product of claim 18, wherein the primary and second models are active models responding to purchase requests.

20. The computer program product of claim 18, wherein the second model replaces the primary model as the active model responding to purchase requests.

21. The computer program product of claim 18, wherein the replacement is based on a prediction that the second model will perform better than the primary model under the current market conditions.

22. The computer program product of claim 18, wherein comparing the valuations includes retrospectively comparing the extent to which the models reflect actual economic performance of advertisements.
